(19) United States
(12) Patent Application Publication
(10) Pub. No.: US 2026/0361750 A1
(43) Pub. Date: Nov. 12, 2026

(54) SYSTEMS AND METHODS FOR PLATFORM-LEVEL EXPOSURE MANAGEMENT

(71) Applicant: Tenable, Inc., Columbia, MD (US)

(72) Inventors: Sashka DAVIS, Vienna, VA (US); Itamar MIZRAHI, Tel Aviv (IL)

(21) Appl. No.: 19/205,690

(22) Filed: May 12, 2025

(51) Int. Cl. H04L 9/40

(52) U.S. Cl. CPC H04L 63/1433; H04L 63/029; H04L 2463/082

(57) ABSTRACT

In some aspects, a method performed by a device, includes determining a plurality of distances of a plurality of attack paths, wherein each attack path of the plurality of attack paths is an attack path from a respective source target of a plurality of source assets to a target asset; determining an asset exposure measure (AEM) of the target asset based at least in part on groupings of the plurality of attack paths from the source assets to the target asset; and performing one or more actions based on the AEM.

### BACKGROUND OF THE DISCLOSURE

### 1. Field of the Disclosure

Aspects relate to systems and methods for platform-level exposure management.

### 2. Description of the Related Art

Metrics have been devised to quantify the exposure of customer assets to vulnerability in enterprise networks. While such metrics may be useful for quantifying the exposure levels of individual assets and for comparing the exposures of different classes of assets, they may not take into account the environment in which various assets exist, interactions with other assets, or attack paths between various assets with various levels of vulnerabilities.

Therefore, there is a need for improved quantification of asset exposure that more accurately reflects the true extent of exposure of an asset to vulnerabilities in a network enterprise environment.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, a method performed by a device includes determining a plurality of distances of a plurality of attack paths, wherein each attack path of the plurality of attack paths is an attack path from a respective source target of a plurality of source assets to a target asset; determining an asset exposure measure (AEM) of the target asset based at least in part on groupings of the plurality of attack paths from the source assets to the target asset; and performing one or more actions based on the AEM.

In some aspects, a device includes one or more memories; and one or more processors communicatively coupled to the one or more memories, the one or more processors, either alone or in combination, configured to: determine a plurality of distances of a plurality of attack paths, wherein each attack path of the plurality of attack paths is an attack path from a respective source target of a plurality of source assets to a target asset; determine an asset exposure measure (AEM) of the target asset based at least in part on groupings of the plurality of attack paths from the source assets to the target asset; and perform one or more actions based on the AEM.

In some aspects, a non-transitory computer-readable medium storing computer-executable instructions that, when executed by a device, cause the device to: determine a plurality of distances of a plurality of attack paths, wherein each attack path of the plurality of attack paths is an attack path from a respective source target of a plurality of source assets to a target asset; determine an asset exposure measure (AEM) of the target asset based at least in part on groupings of the plurality of attack paths from the source assets to the target asset; and perform one or more actions based on the AEM.

Other objects and advantages associated with the aspects disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary network having various assets that can be managed using a vulnerability management system, according to various aspects.

FIG. 2 illustrates another exemplary network having various assets that can be managed using a vulnerability management system, according to various aspects.

FIG. 3 illustrates a diagram of an example system suitable for interactive remediation of vulnerabilities of web applications based on scanning of web applications.

FIG. 4 illustrates a server, according to aspects of the disclosure.

FIG. 5 generally illustrates a user equipment (UE) in accordance with aspects of the disclosure.

FIG. 6 illustrates an example neural network, according to aspects of the disclosure.

FIG. 7 illustrates cloud network architecture, in accordance with aspects of the disclosure.

FIG. 8 illustrates a process, in accordance with aspects of the disclosure.

FIG. 9 illustrates an example of attack paths from three different source assets to a target asset, according to aspects of the disclosure.

FIG. 10 illustrates an example of transformation of the attack paths of FIG. 9 into distances, according to aspects of the disclosure.

FIG. 11 illustrates an example of the exposure of a critical asset due to various attack paths, according to aspects of the disclosure.

FIG. 12 illustrates an example of categorizing the exposure of a critical asset, according to aspects of the disclosure.

FIG. 13 illustrates an example of multiple attack paths originating from a single source node, according to aspects of the disclosure.

FIG. 14 illustrates an example of multiple attack paths originating from multiple distinct source nodes, according to aspects of the disclosure.

The accompanying drawings are presented to aid in the description of various aspects of the disclosure and are provided solely for illustration of the aspects and not limitation thereof.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the term “asset” and variants thereof may generally refer to any suitable uniquely defined electronic object that has been identified via one or more preferably unique but possibly non-unique identifiers or identification attributes (e.g., a universally unique identifier (UUID), a Media Access Control (MAC) address, a Network BIOS (NetBIOS) name, a Fully Qualified Domain Name (FQDN), an Internet Protocol (IP) address, a tag, a CPU ID, an instance ID, a Secure Shell (SSH) key, a user-specified identifier such as a registry setting, file content, information contained in a record imported from a configuration management database (CMDB), etc.). For example, the various aspects and embodiments described herein contemplate that an asset may be a physical electronic object such as, without limitation, a desktop computer, a laptop computer, a server, a storage device, a network device, a phone, a tablet, a wearable device, an Internet of Things (IoT) device, a set-top box or media player, etc. Furthermore, the various aspects and embodiments described herein contemplate that an asset may be a virtual electronic object such as, without limitation, a cloud instance, a virtual machine instance, a container, etc., a web application that can be addressed via a Uniform Resource Identifier (URI) or Uniform Resource Locator (URL), and/or any suitable combination thereof. Those skilled in the art will appreciate that the above-mentioned examples are not intended to be limiting but instead are intended to illustrate the ever-evolving types of resources that can be present in a modern computer network. As such, the various aspects and embodiments to be described in further detail below may include various techniques to manage network vulnerabilities according to an asset-based (rather than host-based) approach, whereby the various aspects and embodiments described herein contemplate that a particular asset can have multiple unique identifiers (e.g., a UUID and a MAC address) and that a particular asset can have multiples of a given unique identifier (e.g., a device with multiple network interface cards (NICs) may have multiple unique MAC addresses). Furthermore, as will be described in further detail below, the various aspects and embodiments described herein contemplate that a particular asset can have one or more dynamic identifiers that can change over time (e.g., an IP address) and that different assets may share a non-unique identifier (e.g., an IP address can be assigned to a first asset at a first time and assigned to a second asset at a second time). Accordingly, the identifiers or identification attributes used to define a given asset may vary with respect to uniqueness and the probability of multiple occurrences, which may be taken into consideration in reconciling the particular asset to which a given data item refers. Furthermore, in the elastic licensing model described herein, an asset may be counted as a single unit of measurement for licensing purposes. Further, assets may encompass tangential network aspects such as policies, rules and so forth.

Assets may also be implemented within or as part of cloud network architecture (e.g., cloud assets may correspond to instances or virtual machines (VMs), particular devices or groups of devices, distributed resources across multiple devices and/or locations, etc.) By way of examples, cloud assets may include, but are not limited to, any of the following examples which are characterized with respect to AMAZON, GOOGLE and MICROSOFT cloud services (e.g., Amazon Web Services, Microsoft Azure, Google Cloud), e.g.:
‘aws_athena_database’
‘aws_db_instance’
‘aws_db_snapshot’
‘aws_dynamodb_table’
‘aws_ecr_repository’
‘aws_ecr_repository_policy’
‘aws_ecs_cluster’
‘aws_ecs_service’
‘aws_eks_cluster’
‘aws_elb’
‘aws_emr_cluster’
‘aws_instance’
‘aws_nat_gateway’
‘aws_rds_cluster’
‘aws_rds_cluster_instance’
‘aws_redshift_cluster’
‘aws_s3_bucket’
‘aws_s3_bucket_policy’
‘azurerm_container_group’
‘azurerm_container_registry’
‘azurerm_kubernetes_cluster’
‘azurerm_lb’
‘azurerm_linux_virtual_machine’
‘azurerm_mariadb_server’
‘azurerm_mssql_server’
‘azurerm_mssql_virtual_machine’
‘azurerm_mysql_database’
‘azurerm_mysql_server’
‘azurerm_postgresql_database’
‘azurerm_postgresql_server’
‘azurerm_sql_database’
‘azurerm_sql_server’
‘azurerm_storage_container’
‘azurerm_virtual_machine_scale_set’
‘azurerm_windows_virtual_machine’
‘google_bigquery_dataset’
‘google_bigquery_table’
‘google_compute_forwarding_rule’
‘google_compute_global_forwarding_rule’
‘google_compute_instance’
‘google_container_cluster’
‘google_container_registry’
‘google_sql_database’
‘google_sql_database_instance’
‘google_storage_bucket’
‘kubernetes_cluster’
‘kubernetes_pod’

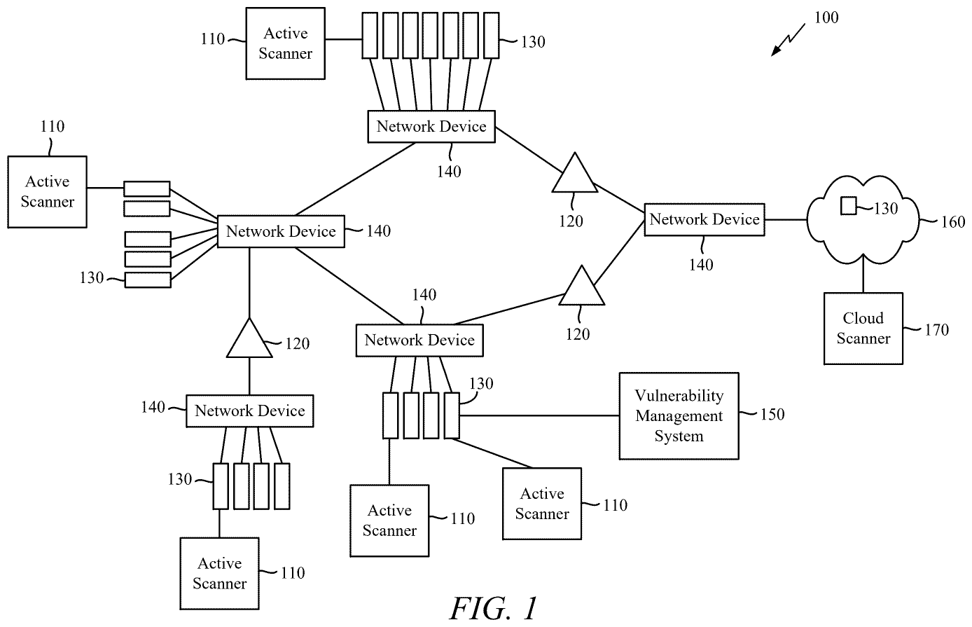

According to various aspects, FIG. 1 illustrates an exemplary network 100 having various assets 130 that are interconnected via one or more network devices 140 and managed using a vulnerability management system 150. More particularly, as noted above, the assets 130 may include various types, including traditional assets (e.g., physical desktop computers, servers, storage devices, etc.), web applications that run self-supporting code, Internet of Things (IoT) devices (e.g., consumer appliances, conference room utilities, cars parked in office lots, physical security systems, etc.), mobile or bring-your-own-device (BYOD) resources (e.g., laptop computers, mobile phones, tablets, wearables, etc.), virtual objects (e.g., containers and/or virtual machine instances that are hosted within the network 100, cloud instances hosted in off-site server environments, etc.). Those skilled in the art will appreciate that the assets 130 listed above are intended to be exemplary only and that the assets 130 associated with the network 100 may include any suitable combination of the above-listed asset types and/or other suitable asset types. Furthermore, in various embodiments, the one or more network devices 140 may include wired and/or wireless access points, small cell base stations, network routers, hubs, spanned switch ports, network taps, choke points, and so on, wherein the network devices 140 may also be included among the assets 130 despite being labelled with a different reference numeral in FIG. 1.

According to various aspects, the assets 130 that make up the network 100 (including the network devices 140 and any assets 130 such as cloud instances that are hosted in an off-site server environment or other remote network 160) may collectively form an attack surface that represents the sum total of resources through which the network 100 may be vulnerable to a cyberattack. As will be apparent to those skilled in the art, the diverse nature of the various assets 130 make the network 100 substantially dynamic and without clear boundaries, whereby the attack surface may expand and contract over time in an often unpredictable manner thanks to trends like BYOD and DevOps, thus creating security coverage gaps and leaving the network 100 vulnerable. For example, due at least in part to exposure to the interconnectedness of new types of assets 130 and abundant software changes and updates, traditional assets like physical desktop computers, servers, storage devices, and so on are more exposed to security vulnerabilities than ever before. Moreover, vulnerabilities have become more and more common in self-supported code like web applications as organizations seek new and innovative ways to improve operations. Although delivering custom applications to employees, customers, and partners can increase revenue, strengthen customer relationships, and improve efficiency, these custom applications may have flaws in the underlying code that could expose the network 100 to an attack. In other examples, IoT devices are growing in popularity and address modern needs for connectivity but can also add scale and complexity to the network 100, which may lead to security vulnerabilities as IoT devices are often designed without security in mind. Furthermore, trends like mobility, BYOD, etc. mean that more and more users and devices may have access to the network 100, whereby the idea of a static network with devices that can be tightly controlled is long gone. Further still, as organizations adopt DevOps practices to deliver applications and services faster, there is a shift in how software is built and short-lived assets like containers and virtual machine instances are used. While these types of virtual assets can help organizations increase agility, they also create significant new exposure for security teams. Even the traditional idea of a perimeter for the network 100 is outdated, as many organizations are connected to cloud instances that are hosted in off-site server environments, increasing the difficulty to accurately assess vulnerabilities, exposure, and overall risk from cyberattacks that are also becoming more sophisticated, more prevalent, and more likely to cause substantial damage.

Accordingly, to address the various security challenges that may arise due to the network 100 having an attack surface that is substantially elastic, dynamic, and without boundaries, the vulnerability management system 150 may include various components that are configured to help detect and remediate vulnerabilities in the network 100.

More particularly, the network 100 may include one or more active scanners 110 configured to communicate packets or other messages within the network 100 to detect new or changed information describing the various network devices 140 and other assets 130 in the network 100. For example, in one implementation, the active scanners 110 may perform credentialed audits or uncredentialed scans to scan certain assets 130 in the network 100 and obtain information that may then be analyzed to identify potential vulnerabilities in the network 100. As used herein “credentialed” scans rely upon user credential(s) for authentication. Credentialed scans can perform a wider variety of checks than non-credentialed scans, which can result in more accurate scan results. Non-credentialed scans by contrast do not rely upon user credential(s) for authentication. More particularly, in one implementation, the credentialed audits may include the active scanners 110 using suitable authentication technologies to log into and obtain local access to the assets 130 in the network 100 and perform any suitable operation that a local user could perform thereon without necessarily requiring a local agent. Alternatively and/or additionally, the active scanners 110 may include one or more agents (e.g., lightweight programs) locally installed on a suitable asset 130 and given sufficient privileges to collect vulnerability, compliance, and system data to be reported back to the vulnerability management system 150. As such, the credentialed audits performed with the active scanners 110 may generally be used to obtain highly accurate host-based data that includes various client-side issues (e.g., missing patches, operating system settings, locally running services, etc.). On the other hand, the uncredentialed audits may generally include network-based scans that involve communicating packets or messages to the appropriate asset(s) 130 and observing responses thereto in order to identify certain vulnerabilities (e.g., that a particular asset 130 accepts spoofed packets that may expose a vulnerability that can be exploited to close established connections). Furthermore, as shown in FIG. 1, one or more cloud scanners 170 may be configured to perform a substantially similar function as the active scanners 110, except that the cloud scanners 170 may also have the ability to scan assets 130 like cloud instances that are hosted in a remote network 160 (e.g., an off-site server environment or other suitable cloud infrastructure).

Additionally, in various implementations, one or more passive scanners 120 may be deployed within the network 100 to observe or otherwise listen to traffic in the network 100, to identify further potential vulnerabilities in the network 100, and to detect activity that may be targeting or otherwise attempting to exploit previously identified vulnerabilities. In one implementation, as noted above, the active scanners 110 may obtain local access to one or more of the assets 130 in the network 100 (e.g., in a credentialed audit) and/or communicate various packets or other messages within the network 100 to illicit responses from one or more of the assets 130 (e.g., in an uncredentialed scan). In contrast, the passive scanners 120 may generally observe (or “sniff”) various packets or other messages in the traffic traversing the network 100 to passively scan the network 100. In particular, the passive scanners 120 may reconstruct one or more sessions in the network 100 from information contained in the sniffed traffic, wherein the reconstructed sessions may then be used in combination with the information obtained with the active scanners 110 to build a model or topology describing the network 100. For example, in one implementation, the model or topology built from the information obtained with the active scanners 110 and the passive scanners 120 may describe any network devices 140 and/or other assets 130 that are detected or actively running in the network 100, any services or client-side software actively running or supported on the network devices 140 and/or other assets 130, and trust relationships associated with the various network devices 140 and/or other assets 130, among other things. In one implementation, the passive scanners 120 may further apply various signatures to the information in the observed traffic to identify vulnerabilities in the network 100 and determine whether any data in the observed traffic potentially targets such vulnerabilities. In one implementation, the passive scanners 120 may observe the network traffic continuously, at periodic intervals, on a pre-configured schedule, or in response to determining that certain criteria or conditions have been satisfied. The passive scanners 120 may then automatically reconstruct the network sessions, build or update the network model, identify the network vulnerabilities, and detect the traffic potentially targeting the network vulnerabilities in response to new or changed information in the network 100.

In one implementation, as noted above, the passive scanners 120 may generally observe the traffic traveling across the network 100 to reconstruct one or more sessions occurring in the network 100, which may then be analyzed to identify potential vulnerabilities in the network 100 and/or activity targeting the identified vulnerabilities, including one or more of the reconstructed sessions that have interactive or encrypted characteristics (e.g., due to the sessions including packets that had certain sizes, frequencies, randomness, or other qualities that may indicate potential backdoors, covert channels, or other vulnerabilities in the network 100). Accordingly, the passive scanners 120 may monitor the network 100 in substantially real-time to detect any potential vulnerabilities in the network 100 in response to identifying interactive or encrypted sessions in the packet stream (e.g., interactive sessions may typically include activity occurring through keyboard inputs, while encrypted sessions may cause communications to appear random, which can obscure activity that installs backdoors or rootkit applications). Furthermore, in one implementation, the passive scanners 120 may identify changes in the network 100 from the encrypted and interactive sessions (e.g., an asset 130 corresponding to a new e-commerce server may be identified in response to the passive scanners 120 observing an encrypted and/or interactive session between a certain host located in the remote network 160 and a certain port that processes electronic transactions). In one implementation, the passive scanners 120 may observe as many sessions in the network 100 as possible to provide optimal visibility into the network 100 and the activity that occurs therein. For example, in one implementation, the passive scanners 120 may be deployed at any suitable location that enables the passive scanners 120 to observe traffic going into and/or out of one or more of the network devices 140. In one implementation, the passive scanners 120 may be deployed on any suitable asset 130 in the network 100 that runs a suitable operating system (e.g., a server, host, or other device that runs Red Hat Linux or FreeBSD open source operating system, a UNIX, Windows, or Mac OS X operating system, etc.).

Furthermore, in one implementation, the various assets and vulnerabilities in the network 100 may be managed using the vulnerability management system 150, which may provide a unified security monitoring solution to manage the vulnerabilities and the various assets 130 that make up the network 100. In particular, the vulnerability management system 150 may aggregate the information obtained from the active scanners 110 and the passive scanners 120 to build or update the model or topology associated with the network 100, which may generally include real-time information describing various vulnerabilities, applied or missing patches, intrusion events, anomalies, event logs, file integrity audits, configuration audits, or any other information that may be relevant to managing the vulnerabilities and assets in the network 100. As such, the vulnerability management system 150 may provide a unified interface to mitigate and manage governance, risk, and compliance in the network 100.

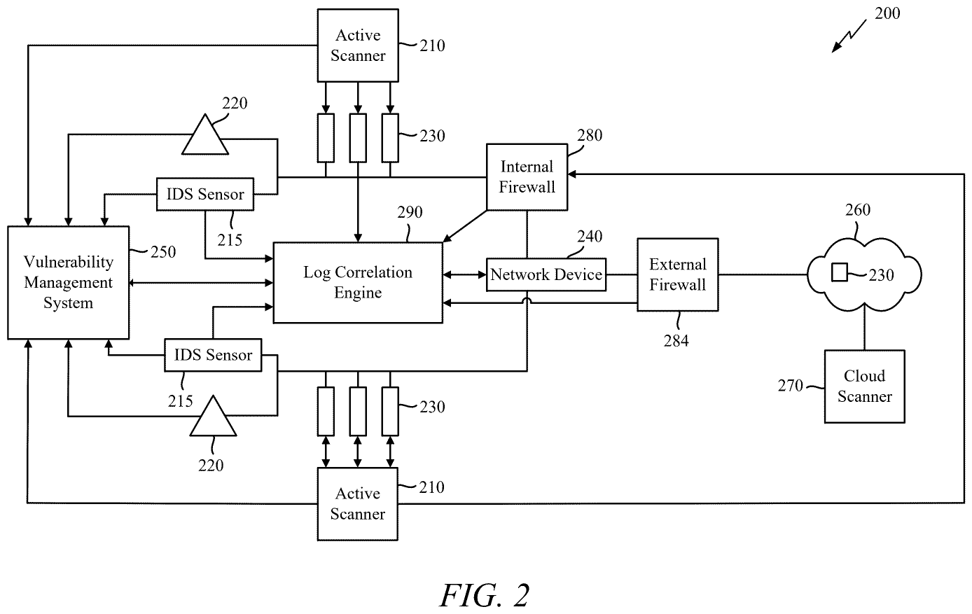

According to various aspects, FIG. 2 illustrates another exemplary network 200 with various assets 230 that can be managed using a vulnerability management system 250. In particular, the network 200 shown in FIG. 2 may have various components and perform substantially similar functionality as described above with respect to the network 100 shown in FIG. 1. For example, in one implementation, the network 200 may include one or more active scanners 210 and/or cloud scanners 270, which may interrogate assets 230 in the network 200 to build a model or topology of the network 200 and identify various vulnerabilities in the network 200, one or more passive scanners 220 that can passively observe traffic in the network 200 to further build the model or topology of the network 200, identify further vulnerabilities in the network 200, and detect activity that may potentially target or otherwise exploit the vulnerabilities. Additionally, in one implementation, a log correlation engine 290 may be arranged to receive logs containing events from various sources distributed across the network 200. For example, in one implementation, the logs received at the log correlation engine 290 may be generated by internal firewalls 280, external firewalls 284, network devices 240, assets 230, operating systems, applications, or any other suitable resource in the network 200. Accordingly, in one implementation, the information obtained from the active scanners 210, the cloud scanners 270, the passive scanners 220, and the log correlation engine 290 may be provided to the vulnerability management system 250 to generate or update a comprehensive model associated with the network 200 (e.g., topologies, vulnerabilities, assets, etc.).

In one implementation, the active scanners 210 may be strategically distributed in locations across the network 200 to reduce stress on the network 200. For example, the active scanners 210 may be distributed at different locations in the network 200 in order to scan certain portions of the network 200 in parallel, whereby an amount of time to perform the active scans may be reduced. Furthermore, in one implementation, one or more of the active scanners 210 may be distributed at a location that provides visibility into portions of a remote network 260 and/or offloads scanning functionality from the managed network 200. For example, as shown in FIG. 2, one or more cloud scanners 270 may be distributed at a location in communication with the remote network 260, wherein the term “remote network” as used herein may refer to the Internet, a partner network, a wide area network, a cloud infrastructure, and/or any other suitable external network. As such, the terms “remote network,” “external network,” “partner network,” and “Internet” may all be used interchangeably to suitably refer to one or more networks other than the networks 100, 200 that are managed using the vulnerability management systems 150, 250, while references to “the network” and/or “the internal network” may generally refer to the areas that the systems and methods described herein may be used to protect or otherwise manage. Accordingly, in one implementation, limiting the portions in the managed network 200 and/or the remote network 260 that the active scanners 210 are configured to interrogate, probe, or otherwise scan and having the active scanners 210 perform the scans in parallel may reduce the amount of time that the active scans consume because the active scanners 210 can be distributed closer to scanning targets. In particular, because the active scanners 210 may scan limited portions of the network 200 and/or offload scanning responsibility to the cloud scanners 270, and because the parallel active scans may obtain information from the different portions of the network 200, the overall amount of time that the active scans consume may substantially correspond to the amount of time associated with one active scan.

As such, in one implementation, the active scanners 210 and/or cloud scanners 270 may generally scan the respective portions of the network 200 to obtain information describing vulnerabilities and assets in the respective portions of the network 200. In particular, the active scanners 210 and/or cloud scanners 270 may perform the credentialed and/or uncredentialed scans in the network in a scheduled or distributed manner to perform patch audits, web application tests, operating system configuration audits, database configuration audits, sensitive file or content searches, or other active probes to obtain information describing the network. For example, the active scanners 210 and/or cloud scanners 270 may conduct the active probes to obtain a snapshot that describes assets actively running in the network 200 at a particular point in time (e.g., actively running network devices 240, internal firewalls 280, external firewalls 284, and/or other assets 230). In various embodiments, the snapshot may further include any exposures that the actively running assets to vulnerabilities identified in the network 200 (e.g., sensitive data that the assets contain, intrusion events, anomalies, or access control violations associated with the assets, etc.), configurations for the actively running assets (e.g., operating systems that the assets run, whether passwords for users associated with the assets comply with certain policies, whether assets that contain sensitive data such as credit card information comply with the policies and/or industry best practices, etc.), or any other information suitably describing vulnerabilities and assets actively detected in the network 200. In one implementation, in response to obtaining the snapshot of the network 200, the active scanners 210 and/or cloud scanners 270 may then report the information describing the snapshot to the vulnerability management system 250, which may use the information provided by the active scanners 210 to remediate and otherwise manage the vulnerabilities and assets in the network.

Furthermore, in one implementation, the passive scanners 220 may be distributed at various locations in the network 200 to monitor traffic traveling across the network 200, traffic originating within the network 200 and directed to the remote network 260, and traffic originating from the remote network 260 and directed to the network 200, thereby supplementing the information obtained with the active scanners 210. For example, in one implementation, the passive scanners 220 may monitor the traffic traveling across the network 200 and the traffic originating from and/or directed to the remote network 260 to identify vulnerabilities, assets, or information that the active scanners 210 may be unable to obtain because the traffic may be associated with previously inactive assets that later participate in sessions on the network. Additionally, in one implementation, the passive scanners 220 may be deployed directly within or adjacent to an intrusion detection system sensor 215, which may provide the passive scanners 220 with visibility relating to intrusion events or other security exceptions that the intrusion detection system (IDS) sensor 215 identifies. In one implementation, the IDS may be an open source network intrusion prevention and detection system (e.g., Snort), a packet analyzer, or any other system that having a suitable IDS sensor 215 that can detect and prevent intrusion or other security events in the network 200.

Accordingly, in various embodiments, the passive scanners 220 may sniff one or more packets or other messages in the traffic traveling across, originating from, or directed to the network 200 to identify new network devices 240, internal firewalls 280, external firewalls 284, or other assets 230 in addition to open ports, client/server applications, any vulnerabilities, or other activity associated therewith. In addition, the passive scanners 220 may further monitor the packets in the traffic to obtain information describing activity associated with web sessions, Domain Name System (DNS) sessions, Server Message Block (SMB) sessions, File Transfer Protocol (FTP) sessions, Network File System (NFS) sessions, file access events, file sharing events, or other suitable activity that occurs in the network 200. In one implementation, the information that the passive scanners 220 obtains from sniffing the traffic traveling across, originating from, or directed to the network 200 may therefore provide a real-time record describing the activity that occurs in the network 200. Accordingly, in one implementation, the passive scanners 220 may behave like a security motion detector on the network 200, mapping and monitoring any vulnerabilities, assets, services, applications, sensitive data, and other information that newly appear or change in the network 200. The passive scanners 220 may then report the information obtained from the traffic monitored in the network to the vulnerability management system 250, which may use the information provided by the passive scanners 220 in combination with the information provided from the active scanners 210 to remediate and otherwise manage the network 200.

In one implementation, as noted above, the network 200 shown in FIG. 2 may further include a log correlation engine 290, which may receive logs containing one or more events from various sources distributed across the network 200 (e.g., logs describing activities that occur in the network 200, such as operating system events, file modification events, USB device insertion events, etc.). In particular, the logs received at the log correlation engine 290 may include events generated by one or more of the internal firewalls 280, external firewalls 284, network devices 240, and/or other assets 230 in the network 200 in addition to events generated by one or more operating systems, applications, and/or other suitable sources in the network 200. In one implementation, the log correlation engine 290 may normalize the events contained in the various logs received from the sources distributed across the network 200, and in one implementation, may further aggregate the normalized events with information describing the snapshot of the network 200 obtained by the active scanners 210 and/or the network traffic observed by the passive scanners 220. Accordingly, in one implementation, the log correlation engine 290 may analyze and correlate the events contained in the logs, the information describing the observed network traffic, and/or the information describing the snapshot of the network 200 to automatically detect statistical anomalies, correlate intrusion events or other events with the vulnerabilities and assets in the network 200, search the correlated event data for information meeting certain criteria, or otherwise manage vulnerabilities and assets in the network 200.

Furthermore, in one implementation, the log correlation engine 290 may filter the events contained in the logs, the information describing the observed network traffic, and/or the information describing the snapshot of the network 200 to limit the information that the log correlation engine 290 normalizes, analyzes, and correlates to information relevant to a certain security posture (e.g., rather than processing thousands or millions of events generated across the network 200, which could take a substantial amount of time, the log correlation engine 290 may identify subsets of the events that relate to particular intrusion events, attacker network addresses, assets having vulnerabilities that the intrusion events and/or the attacker network addresses target, etc.). Alternatively (or additionally), the log correlation engine 290 may persistently save the events contained in all of the logs to comply with regulatory requirements providing that all logs must be stored for a certain period of time (e.g., saving the events in all of the logs to comply with the regulatory requirements while only normalizing, analyzing, and correlating the events in a subset of the logs that relate to a certain security posture). As such, the log correlation engine 290 may aggregate, normalize, analyze, and correlate information received in various event logs, snapshots obtained by the active scanners 210 and/or cloud scanners 270, and/or the activity observed by the passive scanners 220 to comprehensively monitor, remediate, and otherwise manage the vulnerabilities and assets in the network 200. Additionally, in one implementation, the log correlation engine 290 may be configured to report information relating to the information received and analyzed therein to the vulnerability management system 250, which may use the information provided by the log correlation engine 290 in combination with the information provided by the passive scanners 220, the active scanners 210, and the cloud scanners 270 to remediate or manage the network 200.

Accordingly, in various embodiments, the active scanners 210 and/or cloud scanners 270 may interrogate any suitable asset 230 in the network 200 to obtain information describing a snapshot of the network 200 at any particular point in time, the passive scanners 220 may continuously or periodically observe traffic traveling in the network 200 to identify vulnerabilities, assets, or other information that further describes the network 200, and the log correlation engine 290 may collect additional information to further identify the vulnerabilities, assets, or other information describing the network 200. The vulnerability management system 250 may therefore provide a unified solution that aggregates vulnerability and asset information obtained by the active scanners 210, the cloud scanners 270, the passive scanners 220, and the log correlation engine 290 to comprehensively manage the network 200.

Security auditing applications typically display security issues (such as vulnerabilities, security misconfigurations, weaknesses, etc.) paired with a particular solution for that given issue. Certain security issues may share a given solution, or have solutions which are superseded or otherwise rendered unnecessary by other reported solutions. Embodiments of the disclosure relate to improving an efficiency by which security issues are reported, managed and/or rectified based on solution supersedence.

In accordance with a first embodiment, when working with security reporting datasets with sparse metadata available, the reported solutions for each security issue are combined, and various “rulesets” are applied against the combined solutions to de-duplicate them and remove solutions that have been superseded by other solutions. As used herein, a ruleset is a set of rules that govern when a solution is to be removed or merged with another and how that merge is to be accomplished. In an example, when solution texts not matching a given ruleset are discovered they are flagged for manual review. Examples of rules that may be included in one or more rulesets are as follows:
If there is more than one matching solution in the solution list, remove all but one of those solutions.
For solutions matching “Upgrade to <product> x.y.z” where x, y, and z are integers, select a single result with the highest x.y.z value (comparing against x first, then y, then z).
For solutions matching “Apply fix <fix> to <product>”, create a new combined solution where <fix> for each solution is concatenated into a comma separated list for a given <product>.

In accordance with a second embodiment, when working with datasets with metadata available that have an identifier that allows grouping of solutions based on product (e.g., common product enumeration (CPE)) and timestamp information on when a fix has become available, the solutions for each group can be filtered with only display the latest “top level” solution for each group being displayed. In an example, the first and second embodiments can be implemented in conjunction with each other to produce a further refined solution set.

As used herein, a “plug-in” contains logic and metadata for an individual security check in a security auditing application. A plugin may check for one or more mitigations/fixes and flag one or more individual security issues. CPE is a standardized protocol of describing and identifying classes of applications, operating systems, and hardware devices present among an enterprise's computing assets. CPE identifiers contain asset type information (OS/Hardware/Application), vendor, product, and can even contain version information. An example CPE string is “cpe:/o:microsoft:windows_vista:6.0:sp1”, where “/o” stands for operating system, Microsoft is the vendor, windows_vista is the product, major version is 6.0, and minor version is SP1. Further, a common vulnerabilities and exposures (CVE) identifier is an identifier from a national database maintained by NIST/Mitre which keeps a list of known vulnerabilities and exposures. An example identifier would be “CVE-2014-6271” which corresponds to the “ShellShock” vulnerability in the database.

In accordance with one implementation of the second embodiment, solutions (or solution ‘texts’) may first together based on the CPEs in the plugins they were reported in. The solutions are then sorted by the patch publication date from the plugins which they were sourced from. Solutions containing text that matches a pattern that indicates that the solution is likely a patch recommendation can all be removed from the group except the solution associated with the most recent patch. In this manner, patches with identifiers that cannot be easily sorted (e.g., patches with non-numerical identifiers) and/or for which no ruleset pertains in accordance with the first embodiment can be filtered out from the solution set. In some implementations, additional ruleset-based filtering from the first embodiment can also be applied, to filter out (or de-duplicate) additional duplicate solution information.

In accordance with a third embodiment, a security auditing application may evaluate further metadata in the solution report results that is added based upon asset-specific information (e.g., such as individual patches installed, which mitigations and patches are missing, what individual software installations are installed, patch supersedence information, the relationship between the mitigations/patches and security issues, etc.).

Web applications can be an essential way to conduct business. Unfortunately, web applications can also be vulnerable to attacks (e.g., denial of service, disclosure of private information, network infiltration, etc.) due to their exposure to public internet. Thus, addressing vulnerabilities before an attacker can exploit them is a high priority. Web application scanning (WAS) can be performed to identify vulnerabilities associated with web applications. For example, a web application scanner (or simply “scanner”) may be used to scan externally accessible website page for vulnerable web applications.

WAS scans may take a relatively long time to perform, and many scans of redundant web pages or substantially redundant web pages may be performed. For example, a newly scanned web page may include only altered content (e.g., text, images, video, etc.) without any functional alterations, making that scan redundant.

When crawling a web application, a large number of web pages are discovered. Hence, deciding which of these web pages to audit via a security audit scan, and which will provide little to no benefit in auditing via the security audit scan, may help to reduce WAS scan times.

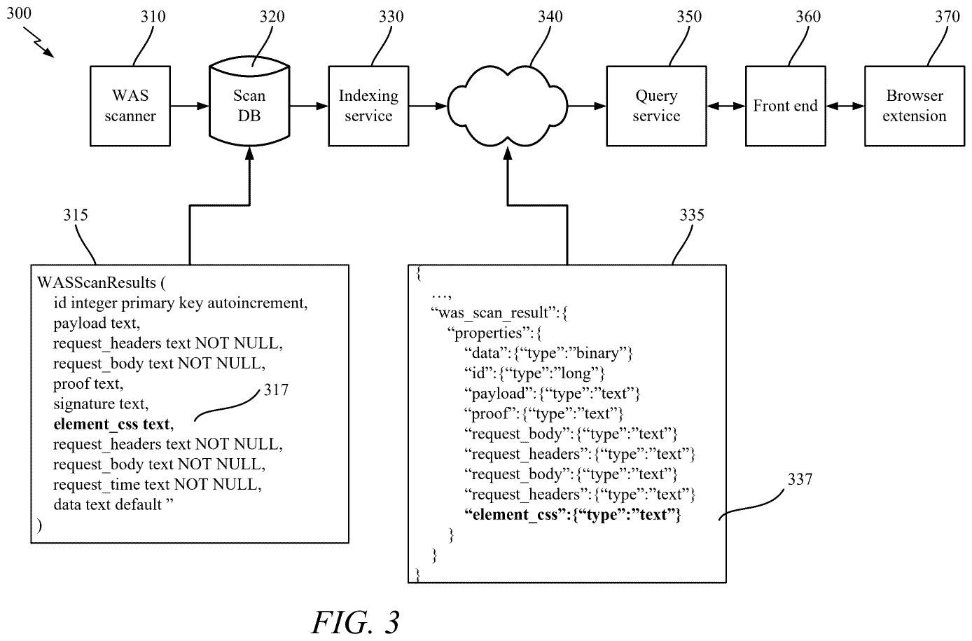

According to various aspects, FIG. 3 illustrates a diagram of an example system 300 suitable for interactive remediation of vulnerabilities of web applications based on scanning of web applications. In particular, as shown in FIG. 3, the system 300 may include a WAS scanner (or simply “scanner”) 310, a scan results 320 (e.g., a database (DB)), a first cloud service 330, a search engine 340, a second cloud service 350, a front end 360, and a browser extension 370. The first and second cloud services 330, 350 may be a same cloud service or different cloud services.

Generally, the scanner 310 may include an element selector for the vulnerable element as a part of its result placed into the scan results 320. Examples (not necessarily exhaustive) of an element selector may include CSS selector, XPath selector, Node number selector, Name selector, Id selector, LinkText selector, and so on. This information may then be passed into the search engine 340 by the first cloud service 330 and included in results from the second cloud service 350 when queried for data about specific vulnerabilities, e.g., from the front end 360. If an element selector exists, the front end 360 (e.g., browser) may include a button that links back to the vulnerable URL and element.

The scanner 310 may be configured to scan web pages to identify one or more vulnerabilities of web applications, i.e., vulnerabilities of elements in web pages. In particular, the scanner 310 may include a selector (not shown) for the vulnerable element in the scan results 320. For example, the selector may implement a scanner function (selector create function) that will take the current element and produce an element selector from it. The URL the element appears on may be included as separate data. A final test may be run before including the data to ensure that the element can be gotten to or otherwise accessible without any extra browser steps that the system is unaware of. Such data may be kept in a table in the scan results 320. For example, FIG. 3 illustrates a VulnerabilitiesDetected table 315, which includes a field for an element selector 317 denoted as “element_css”, which is of text type.

The first cloud service 330 may be configured to index the search results within scan results 320. In particular, the first cloud service 330 may be configured to ensure that the field for the element selector 317 is included when the search engine 340 performs a search. In FIG. 3, it is seen the “was_scan_results” 335 data includes the element selector data 337, which is denoted as “element_css”:{“type”:“text”}.

The second cloud service 350 may be configured to query the search engine 340 for results of WAS scanning, e.g., performed by the scanner 310. In particular, the second cloud service 350 may be configured to query the search engine 340 for the element selector data 337. For example, the second cloud service 350 may submit the following query to pick up the element selector data 337 and return its response, e.g., to the front end 360.
GET /scans/{scanId}/hosts/{hostId}/plugins/{pluginId}

The front end 360 may be configured to receive the WAS scanning results data, including the element selector data for the vulnerable elements. The front end 360 may also be configured to include a button or some other visible element, which when activated (e.g., pressed by a user) will pass message to the browser extension 370 (e.g., chrome extension). The front end 360 may pass at least the following data in the message to the browser extension 370:
URL
Element selector
Plugin ID

The browser extension 370 may be configured to take the message passed from the front end 360, open the URL, and highlight and snap to the vulnerable element. In some aspects, the browser extension 370 may open the URL in a new tab of the browser.

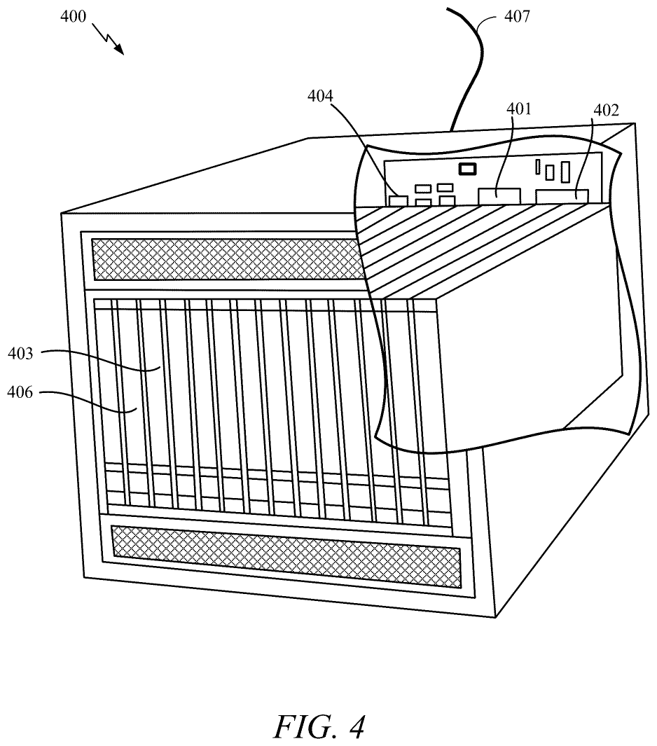

The various embodiments may be implemented on any of a variety of commercially available server devices, such as server 400 illustrated in FIG. 4. In an example, the server 400 may correspond to one example configuration of a server on which a security auditing application may execute, which in certain implementations may be included as part of the vulnerability management system 150 of FIG. 1 or the vulnerability management system 250 of FIG. 2 or WAS scanner 300 of FIG. 3. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet.

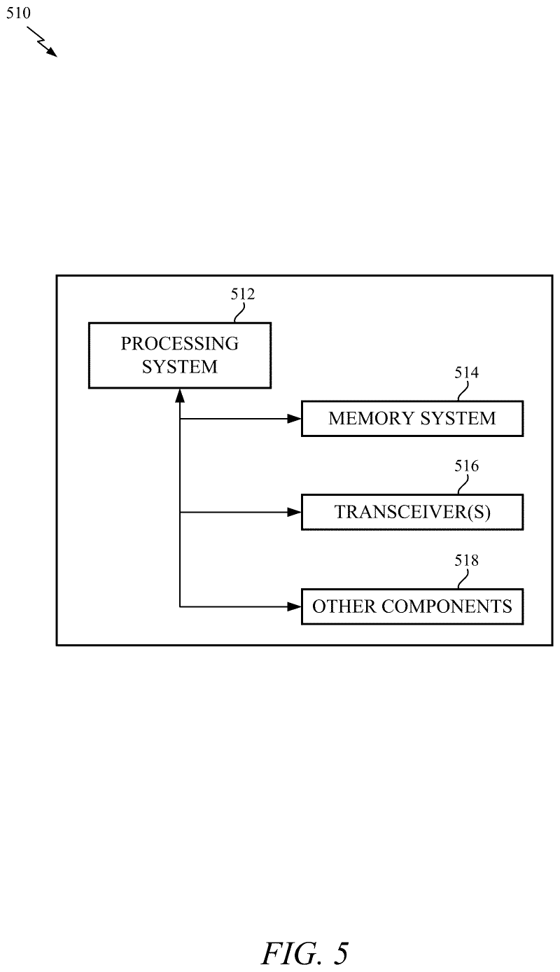

While FIG. 4 illustrates an example whereby a server-type apparatus 400 may implement various processes of the disclosure, in other aspects various aspects of the disclosure may execute on a user equipment (UE), such as UE 510 depicted in FIG. 5.

FIG. 5 generally illustrates a UE 510 in accordance with aspects of the disclosure. In some designs, UE 510 may correspond to any UE-type that is capable of executing the process(es) in accordance with aspects of the disclosure, including but not limited to a mobile phone or tablet computer, a laptop computer, a desktop computer, a wearable device (e.g., smart watch, etc.), and so on. The UE 510 depicted in FIG. 5 includes a processing system 512, a memory system 514, and at least one transceiver 516. The UE 510 may optionally include other components 518 (e.g., a graphics card, various communication ports, etc.).

Machine learning may be used to generate models that may be used to facilitate various aspects associated with processing of data. One specific application of machine learning relates to generation of measurement models for processing of reference signals for positioning (e.g., positioning reference signal (PRS)), such as feature extraction, reporting of reference signal measurements (e.g., selecting which extracted features to report), and so on.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

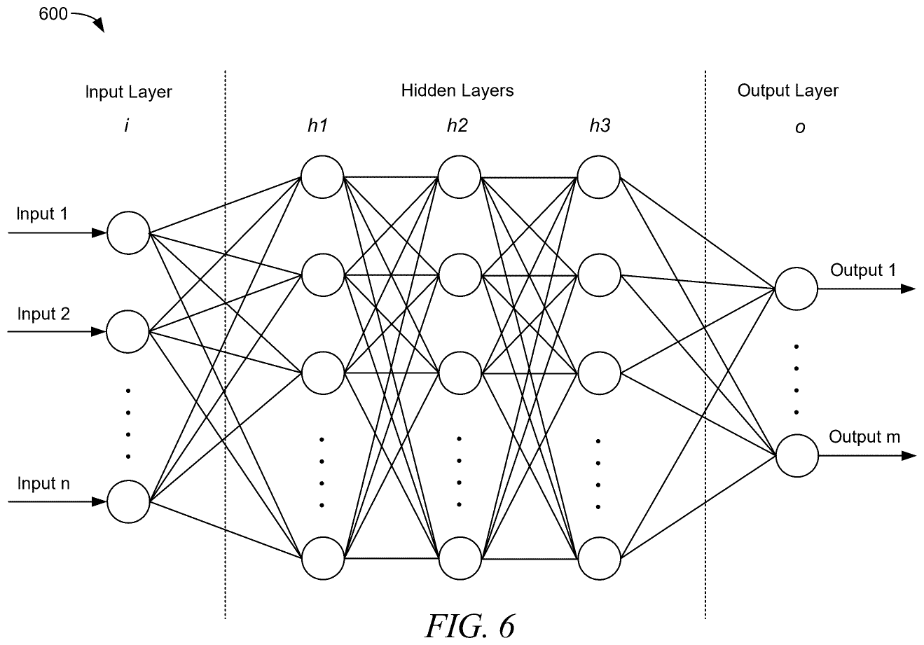

FIG. 6 illustrates an example neural network 600, according to aspects of the disclosure. The neural network 600 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

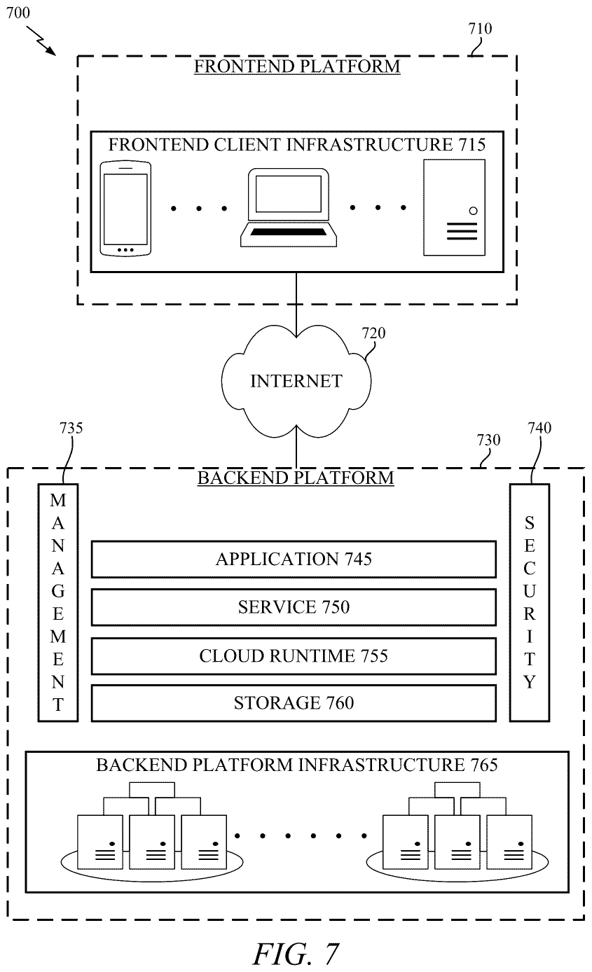

FIG. 7 illustrates cloud network architecture 700, in accordance with aspects of the disclosure. The cloud network architecture 700 comprises a frontend platform 710, an Internet 720, and a backend platform 730. The frontend platform 710 comprises frontend client infrastructure 715, such as smartphones, laptop or desktop computers, and so on, for interfacing with clients (e.g., via web browsers, client applications, etc.). The backend platform 730 comprises a management function 735, a security function 740, an application function 745, a service function 750, a cloud runtime function 755, storage 760 and backend platform infrastructure 765 (e.g., a group of distributed and interconnected computing devices with shareable hardware and/or software resources that support distributed implementation of a set of cloud applications via a respective set of cloud resources).

Referring to FIG. 7, in cloud architecture, each of the components works together to create a cloud computing platform that provides users with on-demand access to resources and services. The backend platform 730 contains all the cloud computing resources, services 750, data storage 760, and applications 745 offered by a cloud service provider. A network, such as Internet 720, is used to connect the frontend platform 710 and backend cloud architecture components of the backend platform 730, facilitating data to be sent back and forth between them. When users interact with the frontend platform (or client-side interface), the user devices send queries to the backend platform 730 using middleware where the service model carries out the specific task or request.

The types of services available to use vary depending on the cloud-based delivery model or service model you have chosen. In some designs, there are three main cloud computing service models, e.g.:
Infrastructure as a service (IaaS): This model provides on-demand access to cloud infrastructure, such as servers, storage, and networking. This eliminates the need to procure, manage, and maintain on-premises infrastructure.
Platform as a service (PaaS): This model offers a computing platform with all the underlying infrastructure and software tools needed to develop, run, and manage applications.
Software as a service (SaaS): This model offers cloud-based applications that are delivered and maintained by the service provider, eliminating the need for end users to deploy software locally.

In some designs, cloud architecture may also be characterized in terms of cloud architecture layers, e.g.:
Hardware: The servers, storage, network devices, and other hardware that power the cloud.
Virtualization: An abstraction layer that creates a virtual representation of physical computing and storage resources. This allows multiple applications to use the same resources.
Application and service: This layer coordinates and supports requests from the frontend user interface, offering different services based on the cloud service model, from resource allocation to application development tools to web-based applications.

In some designs, various types of cloud architecture may be implemented, e.g.:
Public cloud architecture uses cloud computing resources and physical infrastructure that is owned and operated by a third-party cloud service provider. Public clouds enable you to scale resources easily without having to invest in your own hardware or software, but use multi-tenant architectures that serve other customers at the same time.
Private cloud architecture refers to a dedicated cloud that is owned and managed by your organization. It is privately hosted on-premises in your own data center, providing more control over resources and more security over data and infrastructure. However, this architecture is considerably more expensive and requires more IT expertise to maintain.
Hybrid cloud architecture uses both public and private cloud architecture to deliver a flexible mix of cloud services. A hybrid cloud allows you to migrate workloads between environments, allowing you to use the services that best suit your business demands and the workload. Hybrid cloud architectures are often the solution of choice for businesses that need control over their data but also want to take advantage of public cloud offerings.
Multicloud architecture uses cloud services from multiple cloud providers. Multicloud environments are gaining popularity for their flexibility and ability to better match use cases to specific offerings, regardless of vendor.

In some designs, components of cloud architecture include:
Virtualization: Clouds are built upon the virtualization of servers, storage, and networks. Virtualized resources are a software-based, or virtual, representation of a physical resource such as servers or storage. This abstraction layer facilitates multiple applications to utilize the same physical resources, thereby increasing the efficiency of servers, storage, and networking throughout the enterprise.
Infrastructure: loud infrastructure includes all the components of traditional data centers including servers, persistent storage, and networking gear including routers and switches.
Middleware: As in traditional data centers, these software components such as databases and communications applications enable networked computers, applications, and software to communicate with each other.
Management: These tools enable continuous monitoring of a cloud environment's performance and capacity. IT teams can track usage, deploy new apps, integrate data, and ensure disaster recovery, all from a single console.
Automation software: The delivery of critical IT services through automation and pre-defined policies can significantly ease IT workloads, streamline application delivery, and reduce costs. In cloud architecture, automation is used to easily scale up system resources to accommodate a spike in demand for compute power, deploy applications to meet fluctuating market demands, or ensure governance across a cloud environment.

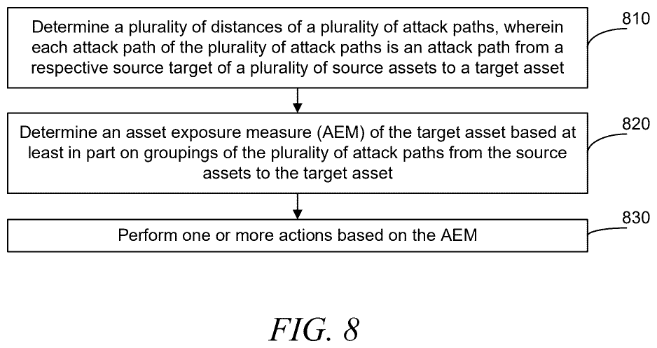

FIG. 8 illustrates a process 800, in accordance with aspects of the disclosure. The process 800 of FIG. 8 may be performed by a device, such as a network device 140, a network device 240, a cloud service 350, a server 400 or a UE 510, for example.

Referring to FIG. 8, at 810, the device (e.g., processor(s) 401, processing system 512, etc.) determines a plurality of distances of a plurality of attack paths, wherein each attack path of the plurality of attack paths is an attack path from a respective source target of a plurality of source assets to a target asset.

Referring to FIG. 8, at 820, the device (e.g., processor(s) 401, processing system 512, etc.) determines an asset exposure measure (AEM) of the target asset based at least in part on groupings of the plurality of attack paths from the source assets to the target asset.

Referring to FIG. 8, at 830, the device (e.g., processor(s) 401, processing system 512, network access ports 404, transceiver(s) 516, etc.) performs one or more actions based on the AEM.

Process 800 may include additional implementations, such as any single implementation or any combination of implementations described below and/or in connection with one or more other processes described elsewhere herein.

Although FIG. 8 shows example blocks of process 800, in some implementations, process 800 may include additional blocks, fewer blocks, different blocks, or differently arranged blocks from those depicted in FIG. 8. Additionally, or alternatively, two or more of the blocks of process 800 may be performed in parallel, or performed in a sequence different from the sequence depicted in FIG. 8.

According to aspects of the disclosure, improved schemes are provided for the quantification of asset exposure that more accurately reflects the true extent of exposure of an asset to vulnerabilities in a network enterprise environment. In some aspects, an asset exposure measure (AEM) may be provided as a platform-level metric for quantifying the level of exposure of a given asset. In some aspects, the AEM may be a function of various available platform data that captures interactions between assets and may be applied to any asset class in a data model that encompasses accounts, identities, devices, cloud services, applications, or the like.

In some aspects, the AEM may capture the state of each asset (e.g., source asset, intermediary asset, or target asset) as well as the effects of the environment on the asset through attack path analytics (APA) and/or a MITRE ATT&CK® framework which is widely accepted as a de facto standard for modeling threat scenarios. In some aspects, AEM scores may be used to derive platform-level cyber exposure scores that are natively defined in the platform for holistically evaluating the extent of threat exposure. In some aspects, the AEM may be indicative of platform-level asset exposure that allows comparisons between distinct assets of various classes and prioritizations of different assets based on their platform-level exposure.

In some aspects, the AEM may provide a measure of the extent to which an asset is exposed to threats due to: (1) the state of the asset that includes vulnerabilities and weaknesses present on the asset; (2) the presence of security controls in place, or the lack thereof; and/or (3) the global, direct, and indirect relationships of the asset with respect to all other assets in the enterprise network via APA.

In some aspects, the AEM may be based on one or more advanced threat models influenced by the APA and a comprehensive model of assets in the environment. In some aspects, all attack paths that may reach a given asset (e.g., a target asset or critical asset) may be considered in deriving the AEM. In some aspects, the attack paths may be classified into critical, high, medium, and low exposure categories using an attack path exposure-distance function from each source node (where a source asset is located) to a given target node (where the target asset is located).

In some aspects, the exposure-distance function may take into consideration all components of the attack path, threat intelligence associated with common vulnerabilities and exposures (CVE) (e.g., through vulnerability path ratings (VPRs), common vulnerability scoring system (CVSS) scores, and/or exploit prediction scoring system (EPSS) scores if needed), the importance of tactical objectives of tactics, techniques and procedures (TTPs), the length of the attack path, and/or other factors. In some aspects, the AEM for a given asset may not be limited to a single measure, but instead, may include a family of multiple types of asset exposure measures. In the examples presented below, six types of asset exposure measures (denoted as AEM₁, AEM₂, AEM₃, AME₄, AEM₅ and AEM₆) will be described in further detail.

Given the platform data related to all attack paths that reach a given target asset including all the information known about the attack paths, the procedures (also known as steps) involved, and intermediary assets (if any) from the source asset to the target asset, a family of AEMs may be obtained based on that information. In some aspects, the family of AEMs for a given target asset may be based at least in part on the categories of attack paths such as critical, high, medium, and low exposure categories.

In some aspects, an AEM may be obtained based at least in part on APA path transformation with an exposure-distance function. In some aspects, a distance between a source asset and a target asset may be computed by taking into account not only the number of steps along the attack path but also the impact of individual steps.

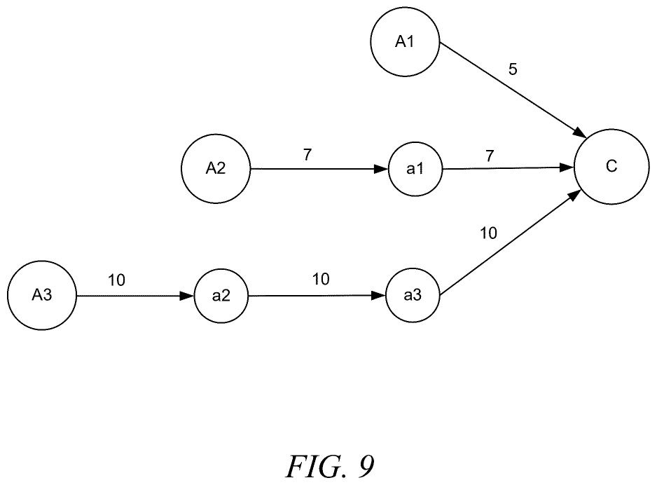

FIG. 9 illustrates an example of attack paths from three different source assets to a target asset, according to aspects of the disclosure. In the example illustrated in FIG. 9, there are three source assets, denoted as A1, A2, A3, with attack paths that reach a target asset, which is a critical asset, denoted as C. For simplicity of illustration, each procedure or step is drawn as an arrow directly connecting two assets. Each procedure or step may be associated with the vulnerability rating of a CVE (e.g., a VPR on a scale of 1 to 10, with 10 representing the highest level of vulnerability), which is shown as a number above each arrow.

In the example shown in FIG. 9, an attack path with a VPR of 5 is directly connected between the source asset A1 and the critical asset C, with no intermediary assets. The attack path originating at the source asset A1 reaches the critical asset C in one hop and thus has a length of one. In some aspects, an attack path with a VPR of 5 may be considered a path of medium criticality. The attack path from the source asset A1 to the critical asset C may be labeled with a weight of 5, which is the VPR of that attack path.

In the example shown in FIG. 9, the attack path originating from source asset A2 to critical asset C includes two hops and thus has a length of two. An intermediary asset a1 is located between the source asset A2 and the critical asset C. This attack path involves two procedures or steps each associated with a relatively high-criticality CVE with a VPR of 7. Thus, each arrow along the attack path A2->a1->C is labeled with a weight of 7 corresponding to the VPR of 7.

In the example shown in FIG. 9, the attack path originating from source asset A3 to critical asset C includes three hops and thus has a length of three. Two intermediary assets a2 and a3 are located along the attack path between the source asset A3 and the critical asset C. This attack path involves three procedures or steps each associated with the highest level of criticality, that is, with a VPR of 10. Thus, each arrow along the attack path A3->a2->a3->C is labeled with a weight of 10 corresponding to the VPR of 10.

From the perspective of an adversary or potential attacker, the attack path A3->a2->a3->C is likely the shortest, even though it involves multiple hops, measured as the number of procedures or steps that need to be executed to reach the critical asset C from the source asset A3. In some aspects, a distance function may be provided to transform the VPRs associated with all the procedures or steps along an attack path when each procedure or step is associated with a CVE. In some aspects, the same transformation may be applied to TTPs that are not associated with CVEs.

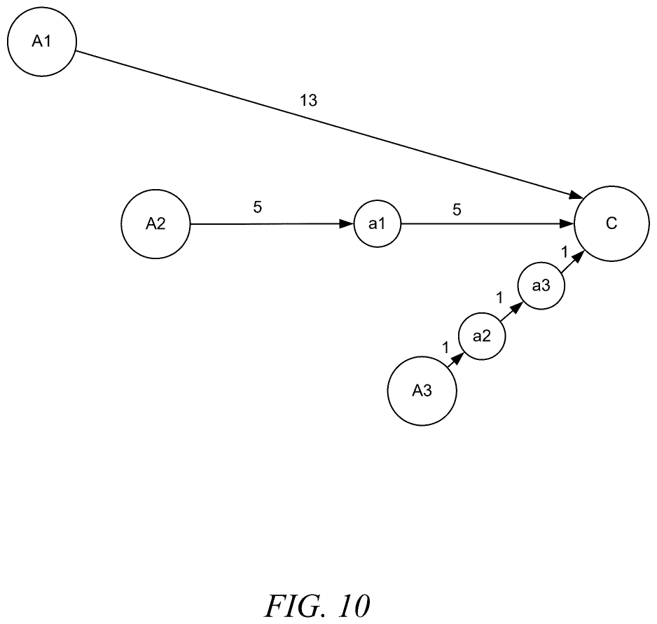

FIG. 10 illustrates an example of transformation of the attack paths of FIG. 9 into distances, according to aspects of the disclosure. In the example illustrated in FIG. 10, the most likely path that an adversary is probably going to exploit is A3->a2->a3->C, which has a distance D(A3,C)=3. The second path, A2->a1->C, which may be less likely to be exploited by an adversary than A2->a2->a3->C, has a distance D (A2, C)=10. The third path A1->C, which is the least likely to be exploited by an adversary among the three attack paths, has a distance D (A1, C)=13. In this example, the third path A1->C is the least likely to be exploited even though it is a one-hop path with no intermediary asset between the source asset A1 and the critical asset C.

In some aspects, the exposure-distance function D from a source asset to a target asset may be roughly inversely proportional to the magnitude of the exposure of the target asset, by considering factors including the number of hops on a given attack path, the severity levels of the CVEs (e.g., using metrics such as VPR, CVSS, EPSS or the like), and the impact of non-CVE based TTPs.

In some aspects, a platform-level AEM may be provided as a function of:
1. All attack paths that reach a target asset (e.g., a critical asset);
2. The exposure caused by each individual attack path through the exposure-distance function;
3. The exposure of source nodes (where the source assets are located) associated with the attack paths;
4. Presence or absence of security controls in place on the target asset:
   a. Security controls in place may be added as edges of different distances;
   b. Asset configuration if audit files are present;
   c. Application configuration (audit files).

In some implementations, the platform-level AEM may be a function of additional and/or alternative factors within the scope of the disclosure. In some aspects, the AEM may be evaluated for a given target asset by computing all attack paths that reach the target asset, and for each attack path, computing the distance (e.g., as an exposure-distance function) from each source asset to the target asset.

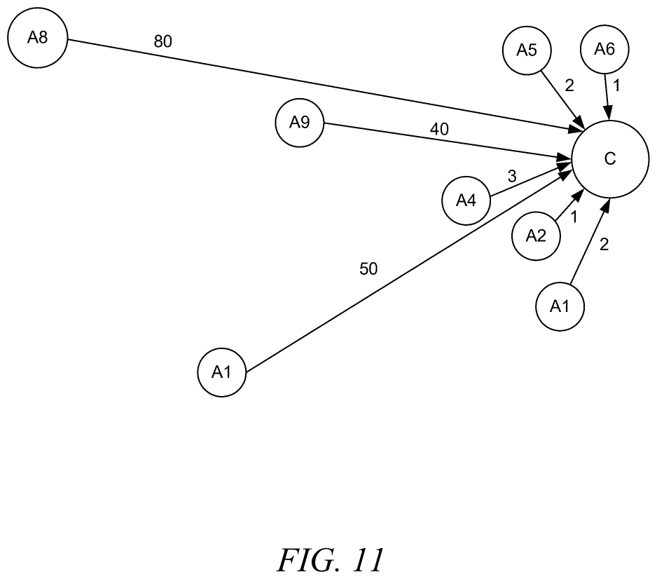

FIG. 11 illustrates an example of the exposure of a critical asset due to various attack paths, according to aspects of the disclosure. In the example illustrated in FIG. 11, the critical asset, denoted as C, may be reached via multiple attack paths, and the attack paths may originate from multiple source assets. In some cases, there may be more than one attack path from a given source asset to the critical asset C.

In the example shown in FIG. 11, the critical asset C is reachable from multiple source assets, denoted as A1, A2, A4, A5, A6, A8 and A9. In this example, there are two attack paths from the source asset A1 to the critical asset C, one with a distance 50 and another with a distance 2. The attack path from the source asset A2 to the critical asset C has a distance of 1. The attack path from the source asset A4 to the critical asset C has a distance of 3. The attack path from the source asset A5 to the critical asset C has a distance of 2. The attack path from the source asset A6 to the critical asset C has a distance of 1. The attack path from the source asset A8 to the critical asset C has a distance of 80. The attack path from the source asset A9 to the critical asset C has a distance of 40.

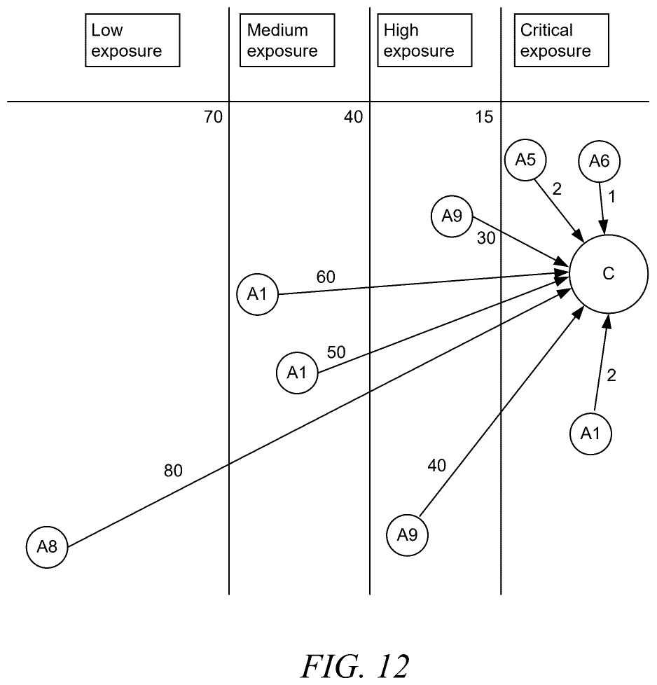

In some aspects, the attack paths may be classified into four categories of exposures, namely, critical exposure, high exposure, medium exposure and low exposure, based on the distances from the source assets to the target asset. FIG. 12 illustrates an example of categorizing the exposure of a critical asset, according to aspects of the disclosure. In the example illustrated in FIG. 12, attack paths with the shortest distances (e.g., distances of 1 and 2) are placed into the critical-exposure category. If the distance from a source node s to a target node t, D(s,t), is less than a threshold critical-exposure distance (CD), then the attack path may be regarded as a critical-exposure path. For example, CD may be set to 15. If D(s,t)<CD=15, then the attack path may be placed into the critical-exposure category.

In some aspects, the remaining path categories (e.g., high exposure, medium exposure and low exposure) may be defined in a similar manner. An attack path may be regarded as a high-exposure path if the distance from a source node s to a target node t, D(s,t), is greater than or equal to CD but less than a threshold high-exposure distance (HD). For example, HD may be set to 40. If D(s,t)∈[CD;HD)=[15;40), then the attack path may be placed into the high-exposure category.

An attack path may be regarded as a medium-exposure path if the distance from a source node s to the target node t, D(s,t), is greater than or equal to HD but less than a threshold medium-exposure distance (MD). For example, MD may be set to 70. If D(s,t)∈[HD;MD)=[40; 70), then the attack path may be placed into the medium-exposure category.

An attack path may be regarded as a low-exposure path if the distance from a source node s to the target t, D(s,t), is greater than or equal to MD. If D(s,t)≥MD=70, then the attack path may be placed into the low-exposure category. In some aspects, a threshold low-exposure distance may be defined for the low-exposure category, and the attack path may be placed into the low-exposure category if D(s,t)∈[MD;LD). In some aspects, the threshold distances for critical, high, medium, and/or low exposure categories (e.g., CD, HD, MD and/or LD) may vary depending on the enterprise network environment.

In some aspects, the AEM for the critical asset C may depend at least in part on the number of attack paths in each category. In some aspects, the numbers of critical-exposure, high-exposure, medium-exposure and low-exposure paths may be counted. In the following description, the numbers of critical-exposure, high-exposure, medium-exposure and low-exposure paths are denoted as Ce, He, Me, Le, respectively.

In some aspects, the number of distinct assets that are the starting nodes (i.e., nodes for the source assets) for the attack paths that eventually reach the critical asset C may be counted. In the following description, the number of distinct source assets is denoted as S. In some aspects, if the critical asset C has local security control (LSC) in place, then a parameter denoted as LCS may signify the presence or absence of local security control. For example, if there is local security control in place at the critical asset C, then LCS may be set to 1. Otherwise, LCS may be set to 0.

In some aspects, the AEM for a given target or critical asset may be more than a single measure but a family of multiple measures. In some aspects, a family of asset exposure measures may be defined based at least in part on attack paths that reach the target node, source nodes from which the attack paths originate, and the presence or absence of local security controls at the target node.

A family of six example AEMs (denoted as AEM₁, AEM₂, AEM₃, AME₄, AEM₅ and AEM₆) are described below for representing the threat exposure of a target asset. Various formulas for deriving AEMs may be provided within the scope of the disclosure. In some aspects, a common thread for the family of AEMs is that they are based at least in part on the attack paths and their exposures. Variations among the family of AEMs may include the manners in which local security controls in place and the sources of the attack paths are taken into account. In the description of AEM₁ through AEM₆ below, each AEMₙ builds on and expands the previous AEMₙ₋₁.

In some aspects, the first asset exposure measure, denoted as AEM₁, may be defined solely based on the number of different classes of attack paths:

AEM₁=0.4Ce+0.3He+0.2Me+0.1Le

where Ce is the normalized version of

$$Ce = \frac{min \{ MAX , Ce \}}{MAX} .$$

In some aspects, the normalization of Ce may simply be thresholding the value of Ce. This is equivalent to assuming that, above a threshold number of attack paths, the exposure due to the number of critical paths Ce may be regarded as being maximal. In some aspects, the value of MAX may be determined accordingly. Similarly, for other types of exposure paths (e.g., high, medium, and low exposure paths), P∈{He, Me, Le},

$$P = \frac{min \{ MAX , P \}}{MAX} .$$

In some aspects, AEM₁ may be a number in the range of [0,1] and may be scaled to 10, 100, 1000, etc., depending on the implementation. The constants 0.4, 0.3, 0.2, 0.1, and MAX in the formulas above may be adjusted for various network environments. In some aspects, the sum of the constant multipliers for Ce, He, Me and Le is one.

In some aspects, the second asset exposure measure, denoted as AEM₂, extends the concept of AEM₁ by adding a local security control (LSC) component:

AEM₂(C)=AEM₁−0.05LSC=0.4Ce+0.3He+0.2Me+0.1Le−Rp LSC

where Rp is the exposure reduction constant due to the presence of local security control in place. In some implementations, the value of Rp may be set to 0.05, which means that the exposure of an asset may be reduced by 5% if it is determined that the target asset is running local security control. In some implementations, customers may set their own values of Rp based on the particular local security control measures in place.

In some aspects, the third asset exposure measure, denoted as AEM₃, extends the concept of AEM₂ by adding a source node component. In some cases, a target asset may be reached by multiple attack paths originating from a single source node. In some cases, a target asset may be reached by multiple attack paths originating from multiple distinct source nodes.

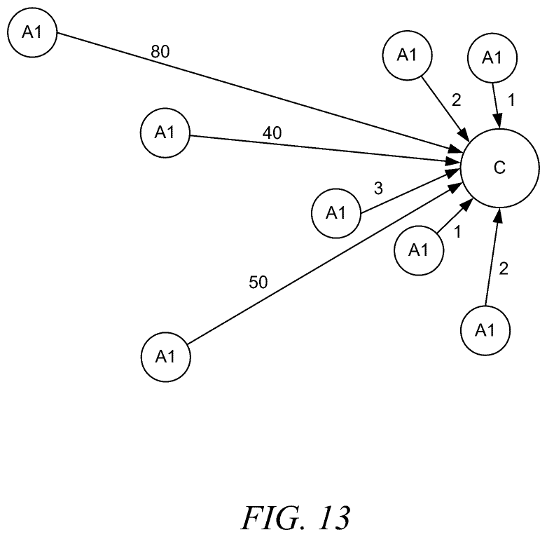

FIG. 13 illustrates an example of multiple attack paths originating from a single source node, according to aspects of the disclosure. In the example illustrated in FIG. 13, multiple attack paths that reach a target asset (e.g., a critical asset denoted as C) may have various distances, but they all originate from a single source node (e.g., the location of a single source asset denoted as A1).

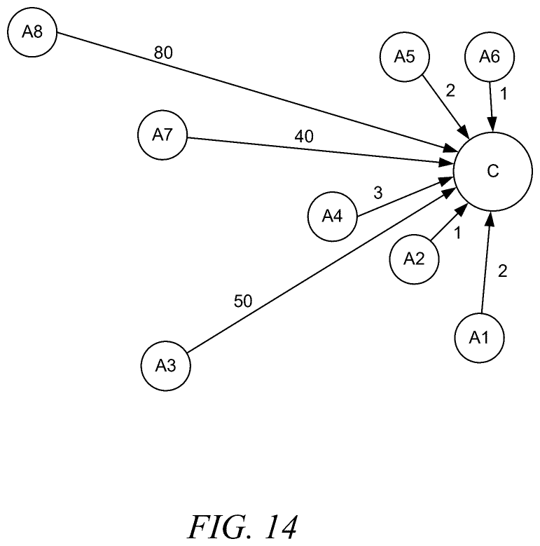

FIG. 14 illustrates an example of multiple attack paths originating from multiple distinct source nodes, according to aspects of the disclosure. In the example illustrated in FIG. 14, multiple attack paths that reach a target asset (e.g., a critical asset denoted as C) originate from multiple distinct source nodes (e.g., the locations of source assets denoted as A1, A2, A3, A4, A5, A6, A7 and A8), even though each attack path has the same distance as the corresponding attack path illustrated in FIG. 13.

Among the example cases illustrated in FIGS. 13 and 14, the second example case illustrated in FIG. 14 may lead to a higher exposure because an adversary may choose from multiple source nodes to initiate the attack. In some aspects, the third AEM, AEM₃, may be provided to distinguish between the example cases illustrated in FIGS. 13 and 14.

In some aspects, the number of distinct source assets S at the starting or source nodes of attack paths leading to the critical asset C may be counted. In some aspects, AEM₃ may take into account the number of distinct source assets S according to the following relationship:

AEM₃(C)=0.35Ce+0.25He+0.14Me+0.1Le+0.16S−Rp LCS

where S is a normalized number of distinct source assets S and the multiplicative constant for S may be set depending on the enterprise network environment. In some aspects, the sum of the multiplicative constants for Ce, He, Me, Le and S is one.

In some aspects, the fourth asset exposure measure, denoted as AEM₄, extends the concept of AEM₃ by introducing granularity into how the source nodes of the attack paths are counted. Instead of simply counting the size of the entire set of source nodes, the number of distinct source nodes for each exposure category (e.g., critical-exposure paths, high-exposure paths, medium-exposure paths, and low-exposure paths) may be counted separately. In some aspects, AEM₄ may be given according to the following relationship:

AEM₄(C)=A(0.5Cp+0.5S_{C})+B(0.5Ch+0.5S_{H})+C(0.5Cm+0.5S_{M})+D(0.5Cl+0.5S_{L})−Rp LCS

where A, B, C and D are constant weights, Cp, Ch, Cm and Cl are normalized numbers of attack paths in the critical, high, medium and low exposure categories, respectively, and S_{C}, S_{H}, S_{M} and S_{L} are normalized numbers of distinct source nodes in the critical, high, medium and low exposure categories, respectively.

In some aspects, conditional logic may be provided for choosing the constant weights A, B, C, and D. In some aspects, the choice of the weights A, B, C and D may determine the contributions of the eight variables Cp, Ch, Cm, Cl, S_{C}, S_{H}, S_{M} and S_{L}. In some aspects, the sum of the four constants (A+B+C+D) is one.

In some aspects, the combined weight of high, medium and low exposures (B+C+D) should not exceed the weight of the critical exposure (A). In some aspects, by capping the combined weight of high, medium and low exposures, the situation in which a source asset having one critical-exposure path to reach a target asset has a lower AEM than another source asset having high, medium and low-exposure paths but no critical-exposure path to reach the target asset may be avoided.

In some aspects, the constant Rp for weighting the contribution of LSC in place may be zero or a negative fraction or percentage. In some aspects, the constant Rp should not be greater than 5% or 0.05, meaning that the presence of LSC in place should reduce the exposure by no more than 5%. The rationale for this limit is that local security control measures are fallible even when they are present. In some implementations, however, customers may be given the option to increase or decrease the constant Rp based on their knowledge of local security control deployment.

In some aspects, the fifth asset exposure measure, denoted as AEM₅, relaxes the path categories and takes into account every exposure distance D of every attack path that reaches a target asset as a separate category instead of four fixed categories (e.g., critical, high, medium and low-exposure categories). In this implementation, there is no need to classify attack paths into categories which would be required for deriving AEM₁, AEM₂, AEM₃ and AEM₄. For each exposure distance D, the number of distinct source nodes and the number of attack paths are counted.

In some aspects, AEM₅ may be derived by the following steps:
1. Compute all attack paths that reach critical asset C
2. Compute the exposure distance D for each attack path that reaches critical asset C
3. Group all attack paths having the same exposure distance D into a distinct exposure distance group
4. For each exposure distance D,
   a. compute the number of distinct source nodes that are the origins of the attack paths
   b. compute the number of attack paths having the exposure distance D
5. Repeat step 4 for all distinct exposure distances of all attack paths originating from any source nodes leading to critical asset C
6. (Optional) Discriminate between different types of LSC in place: endpoint detection and response (EDR) agent running, local firewall (LF) installed and running, and/or anti-virus (AV) agent installed and running

In some aspects, the formula for AEM₅ at critical asset C is given as follows:

$${AEM}_{5} ( C ) = {\sum }_{D} ( \frac{1}{D} \times ( 0.6 \underline{{P}_{D}} + 0.4 \underline{{S}_{D}} ) ) - Rp ( a EDR + b LF + c AV )$$

where D is each exposure distance, P_{D} is a normalized number of attack paths with exposure distance D, S_{D} is a normalized number of distinct source nodes with exposure distance D, Rp is a constant multiplier (e.g., no greater than 0.05), a is a constant multiplier for EDR, b is a constant multiplier for LF, and c is a constant multiplier for AV. In some aspects, the sum of the constants a, b, and c should be one.

In addition or as alternatives to EDR, LF and AV, other customer-related measures may be considered and weighted in the derivation of AEM₅. In some aspects, customer-related measures associated with LSC may be based at least in part on EDR parameters, local or built-in firewall parameters, AV parameters, Linux Foundation security parameters, system and kernel hardening level parameters, or any combination thereof.

In some aspects, a determination may be made as to whether each asset (including the source asset(s) and the target asset) represents an account or identity that has LSC in place. In some aspects, a determination may be made as to whether the LSC of each asset is related to the presence or absence of two-factor authentication (2FA) or multi-factor authentication (MFA). In some aspects, the presence (or absence) of 2FA or MFA may be considered and weighted in the derivation of AEM₅.

In some aspects, a security configuration of the device may be made based on one or more security benchmarks. In some aspects, a determination may be made as to whether the device has been hardened. For example, among the customer-related measures, the system and kernel hardening level parameter may be based on the security configuration and hardening of the device. In some aspects, the security configuration and/or the hardening of the device may be considered and weighted in the derivation of AEM₅.

In some aspects, the groupings of attack paths may be based on the network and security posture of the source nodes associated with the source assets. In some aspects, a determination may be made as to whether the weaknesses, misconfigurations or vulnerabilities associated with the attack paths are known to be exploited by an adversary. In some aspects, the network and security posture of the source nodes and/or knowledge of prior exploitations of weaknesses, misconfigurations or vulnerabilities by an adversary may be considered and weighted in the derivation of AEM₅.

In some aspects, a determination may be made as to whether each source asset is a digital asset or a cloud asset, whether each source asset is Internet-facing or not, and whether each source node has its own LSC or not. In some aspects, these characteristics of source nodes may be considered and weighted in the derivation of AEM₅.

In some aspects, the sixth asset exposure measure, denoted as AEM₆, may be derived in the same manner as AEM₅, except that it uses different weighting constants A_{D} to manage the contributions of attack paths with different exposure distances D instead of using 1/D as the multiplier in AEM₅:

AEM₆(C)=Σ_{D}(A_{D}×(0.6P_{D}+0.4S_{D})−Rp(a EDR+b LF+c AV)

where P_{D} is a normalized number of attack paths of exposure distance D that reach critical asset C, S_{D} is a normalized number of distinct source nodes that are the origins of the attack paths of exposure distance D that reach asset C.

In some aspects, the constant multiplier Rp for customer-related measures (including EDR, LF and AV) may be set to 0.05. In some implementations, customers may be given the option of setting Rp based on their knowledge of LSC measures in place. In some aspects, the sum of the constants a, b, and c should be one. For example, the initial values for these constants may be a=0.70, b=0.25, and c=0.05. Different weights may be applied to EDR, LF and AV depending on the implementation.

In the above-described examples for deriving AEM₅ and AEM₆, the constant multipliers or weights for P_{D} and S_{D} are set at 0.6 and 0.4, respectively. Different weights may be applied depending on the enterprise network environment. For example, equal weighting of the normalized number of attack paths and the normalized number of source nodes (i.e., 0.5P_{D}+0.5S_{D}) may be applicable to sparse graphs where the number of attack paths is roughly proportional to the number of critical assets.

In contrast, a heavier weighting of the normalized number of attack paths may be applicable to dense graphs. For example, the weighted sum (i.e., 0.6P_{D}+0.4S_{D}) in the above-described examples for deriving AEM₅ and AEM₆ may be used for enterprise network environments with relatively dense graphs.

In some aspects, the contribution of each category may be weighted by the distance of each path. For example, attack paths with a length of 1 may be considered to contribute the most to asset exposure, attack paths with a length of 2 may be considered to contribute less than attack paths with a length of 1 (e.g., 50% of the contribution of attack paths of length 1), and so on.

For AEM₆, the contribution of the number of attack paths of each exposure distance D may be weighted by a decreasing sequence of A_{D}, where A₁>A₂>A₃ . . . >A_{max(D)}. Thus, attack paths with the shortest exposure distance of 1 contributes the most to AEM₆, and attack paths with the next shortest exposure distance of 2 contributes less, and so on. In some aspects, if there is no attack path with an exposure distance of 2, then the next shortest path (e.g., attack paths with an exposure distance of 3) may be weighted more heavily but still less than the weight applied to attack paths with the shortest exposure distance of 1.

In some aspects, AEMs according to aspects of the disclosure (e.g., AEM₁, AEM₂, AEM₃, AME₄, AEM₅ and AEM₆) may provide a higher level of abstraction for threat modeling of all known TTPs and CVEs, encompassing identity, cloud, network, industrial control systems (ICS), and any other assets at large. In some aspects, the AEM may provide a platform-level solution because it leverages APA natively, that is, it is intrinsically based on all attack paths that reach the target assets and their internal structure. In some aspects, the AEM may be regarded as a comprehensive measure of exposure function on the entire enterprise environment.

In some aspects, because the AEM natively leverages APA, it may capture all local, global, direct, and indirect relationships of any given target asset with other assets in the environment. In some aspects, the AEM may be decoupled from the asset criticality rating (ACR) as the two notions of exposure and importance or criticality may be independent of each other. In some aspects, AEMs according to aspects of the disclosure may be interpretable. For example, a justification may be made as to why a given asset is exposed by showing:
a. the attack paths that reach the asset;
b. for each exposure category, the number of attack paths that reach the asset; and/or
c. identifications of weaknesses, misconfigurations and/or vulnerabilities involved, enablement of APA on the asset, and/or reasons for the exposure.

In some aspects, AEMs may be used for various purposes, including, for example, identification and prioritization of exposed assets, identification and prioritization of causes of exposure, prioritization of vulnerabilities associated with different attack path categories, and/or prioritization of actions to remediate causes for different attack path categories. In some aspects, AEMs may be used for risk reporting in global enterprise exposure management, risk analysis, and/or cybersecurity assessment.

In the detailed description above, it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1: A method performed by a device, comprising: determining a plurality of distances of a plurality of attack paths, wherein each attack path of the plurality of attack paths is an attack path from a respective source target of a plurality of source assets to a target asset; determining an asset exposure measure (AEM) of the target asset based at least in part on groupings of the plurality of attack paths from the source assets to the target asset; and performing one or more actions based on the AEM.
Clause 2: The method of clause 1, wherein performing the one or more actions comprises: ranking the target asset among a group of assets to facilitate a remediation of vulnerabilities or weaknesses; performing the remediation; outputting a vulnerability report; or any combination thereof.
Clause 3: The method of any of clauses 1 to 2, wherein determining the plurality of distances comprises: determining each distance of the plurality of distances based at least in part on one or more vulnerability or misconfiguration parameters associated with each attack path of the plurality of attack paths.
Clause 4: The method of any of clauses 1 to 3, wherein determining the AEM comprises: determining a category of each attack path of the plurality of attack paths among a plurality of categories of attack paths based on each distance of the plurality of distances; and determining the AEM based at least in part on the categories of attack paths from the source assets to the target asset.
Clause 5: The method of any of clauses 1 to 4, wherein determining the AEM further comprises: determining the AEM based on a weighted sum of a normalized number of attack paths within each category of the plurality of categories.
Clause 6: The method of any of clauses 1 to 5, wherein determining the AEM further comprises: determining the normalized number of attack paths within each category based on dividing a minimum of a constant and a number of attack paths within each category by the constant.
Clause 7: The method of any of clauses 1 to 6, wherein the plurality of categories comprises: a critical exposure category; a high exposure category; a medium exposure category; and a low exposure category.
Clause 8: The method of any of clauses 1 to 7, wherein determining the AEM based on the weighted sum comprises: multiplying a first normalized number of attack paths within the critical exposure category by a first weight to obtain a first exposure measure; multiplying a second normalized number of attack paths within the high exposure category by a second weight to obtain a second exposure measure; multiplying a third normalized number of attack paths within the medium exposure category by a third weight to obtain a third exposure measure; multiplying a fourth normalized number of attack paths within the low exposure category by a fourth weight to obtain a fourth exposure measure; and adding the first exposure measure, the second exposure measure, the third exposure measure and the fourth exposure measure to obtain the weighted sum.
Clause 9: The method of any of clauses 1 to 8, wherein a sum of the first weight, the second weight, the third weight and the fourth weight is one.
Clause 10: The method of any of clauses 1 to 9, wherein determining the AEM further comprises: determining a weighted local security control (LSC) factor; and subtracting the weighted LSC factor from the weighted sum to obtain a difference between the weighted sum and the weighted LSC factor.
Clause 11: The method of any of clauses 1 to 10, wherein determining the AEM further comprises: determining a weighted source node component associated with the source assets; and adding the weighted source node component to the difference between the weighted sum and the weighted LSC factor.
Clause 12: The method of any of clauses 1 to 11, wherein determining the AEM further comprises: obtaining a normalized number of source assets associated with each category; and adding the normalized number of source assets associated with each category to the normalized number of attack paths within each category to obtain a sum for each category.
Clause 13: The method of any of clauses 1 to 12, wherein the weighted sum is obtained by applying a distinct weight to the sum for each category.
Clause 14: The method of any of clauses 1 to 13, further comprising: grouping the attack paths into a plurality of groups, wherein each group of the plurality of groups is associated with a distinct distance among the plurality of distances.
Clause 15: The method of any of clauses 1 to 14, wherein determining the AEM comprises: obtaining a normalized number of attack paths that reach the target asset within each group; obtaining a normalized number of distinct source assets that are origins of the attack paths within each group; and obtaining a weighted sum of the normalized number of attack paths and the normalized number of distinct source assets within each group.
Clause 16: The method of any of clauses 1 to 15, wherein determining the AEM further comprises: dividing the weighted sum within each group by the distinct distance associated with each group to obtain a distance-weighted exposure measure for each group; and obtaining a sum of a plurality of distance-weighted exposure measures for the plurality of groups.
Clause 17: The method of any of clauses 1 to 16, wherein determining the AEM further comprises: subtracting a customer-related measure from the sum of the plurality of distance-weighted exposure measures.
Clause 18: The method of any of clauses 1 to 17, wherein the customer-related measure is based at least in part on a customer-set variable or constant.
Clause 19: The method of any of clauses 1 to 18, wherein the customer-related measure is associated with local security control (LSC) and is based at least in part on: an endpoint detection and response (EDR) parameter; a Linux Foundation (LF) security parameter; local or built-in firewall parameter; system and kernel hardening level parameter; an antivirus (AV) parameter; or any combination thereof.
Clause 20: The method of any of clauses 1 to 19, further comprising: determining whether each asset of the plurality of source assets and the target asset represents an account or identity that has LSC; and determining whether the LSC of each asset is related to a presence or absence of two-factor authentication (2FA) or multi-factor authentication (MFA).
Clause 21: The method of any of clauses 1 to 20, further comprising: determining a security configuration of the device based on one or more security benchmarks; and determining hardening of the device, wherein the system and kernel hardening level parameter is based on the security configuration and hardening of the device.
Clause 22: The method of any of clauses 1 to 21, wherein the groupings of the plurality of attack paths are based on: network and security posture of a plurality of source nodes associated with the plurality of source assets, respectively; a determination of one or more weaknesses, misconfigurations or vulnerabilities associated with one or more attack paths known to be exploited by an adversary; or any combination thereof.
Clause 23: The method of any of clauses 1 to 22, wherein the network and security posture is based on: a determination of whether each source asset of the plurality of source assets is a digital asset or a cloud asset; a determination of whether each source asset of the plurality of source assets is Internet-facing; a determination of whether each source node of the plurality of source nodes has local security control (LSC); or any combination thereof.
Clause 24: A device, comprising: one or more memories; and one or more processors communicatively coupled to the one or more memories, the one or more processors, either alone or in combination, configured to: determine a plurality of distances of a plurality of attack paths, wherein each attack path of the plurality of attack paths is an attack path from a respective source target of a plurality of source assets to a target asset; determine an asset exposure measure (AEM) of the target asset based at least in part on groupings of the plurality of attack paths from the source assets to the target asset; and perform one or more actions based on the AEM.
Clause 25: The device of clause 24, wherein the one or more processors, when performing the one or more actions, are configured to: rank the target asset among a group of assets to facilitate a remediation of vulnerabilities or weaknesses; perform the remediation; output a vulnerability report; and or any combination thereof.
Clause 26: The device of any of clauses 24 to 25, wherein the one or more processors, when determining the plurality of distances, are configured to: determine each distance of the plurality of distances based at least in part on one or more vulnerability or misconfiguration parameters associated with each attack path of the plurality of attack paths.
Clause 27: The device of any of clauses 24 to 26, wherein the one or more processors, when determining the AEM, are configured to: determine a category of each attack path of the plurality of attack paths among a plurality of categories of attack paths based on each distance of the plurality of distances; and determine the AEM based at least in part on the categories of attack paths from the source assets to the target asset.
Clause 28: The device of any of clauses 24 to 27, wherein the one or more processors, when determining the AEM, are configured to: determine the AEM based on a weighted sum of a normalized number of attack paths within each category of the plurality of categories.
Clause 29: The device of any of clauses 24 to 28, wherein the one or more processors, when determining the AEM, are configured to: determine the normalized number of attack paths within each category based on dividing a minimum of a constant and a number of attack paths within each category by the constant.
Clause 30: The device of any of clauses 24 to 29, wherein the plurality of categories comprises: a critical exposure category; a high exposure category; a medium exposure category; and a low exposure category.
Clause 31: The device of any of clauses 24 to 30, wherein the one or more processors, when determining the AEM based on the weighted sum, are configured to: multiply a first normalized number of attack paths within the critical exposure category by a first weight to obtain a first exposure measure; multiply a second normalized number of attack paths within the high exposure category by a second weight to obtain a second exposure measure; multiply a third normalized number of attack paths within the medium exposure category by a third weight to obtain a third exposure measure; multiply a fourth normalized number of attack paths within the low exposure category by a fourth weight to obtain a fourth exposure measure; and add the first exposure measure, the second exposure measure, the third exposure measure and the fourth exposure measure to obtain the weighted sum.
Clause 32: The device of any of clauses 24 to 31, wherein a sum of the first weight, the second weight, the third weight and the fourth weight is one.
Clause 33: The device of any of clauses 24 to 32, wherein the one or more processors, when determining the AEM, are configured to: determine a weighted local security control (LSC) factor; and subtract the weighted LSC factor from the weighted sum to obtain a difference between the weighted sum and the weighted LSC factor.
Clause 34: The device of any of clauses 24 to 33, wherein the one or more processors, when determining the AEM, are configured to: determine a weighted source node component associated with the source assets; and add the weighted source node component to the difference between the weighted sum and the weighted LSC factor.
Clause 35: The device of any of clauses 24 to 34, wherein the one or more processors, when determining the AEM, are configured to: obtain a normalized number of source assets associated with each category; and add the normalized number of source assets associated with each category to the normalized number of attack paths within each category to obtain a sum for each category.
Clause 36: The device of any of clauses 24 to 35, wherein the weighted sum is obtained by applying a distinct weight to the sum for each category.
Clause 37: The device of any of clauses 24 to 36, wherein the one or more processors, either alone or in combination, are further configured to: group the attack paths into a plurality of groups, wherein each group of the plurality of groups is associated with a distinct distance among the plurality of distances.
Clause 38: The device of any of clauses 24 to 37, wherein the one or more processors, when determining the AEM, are configured to: obtain a normalized number of attack paths that reach the target asset within each group; obtain a normalized number of distinct source assets that are origins of the attack paths within each group; and obtain a weighted sum of the normalized number of attack paths and the normalized number of distinct source assets within each group.
Clause 39: The device of any of clauses 24 to 38, wherein the one or more processors, when determining the AEM, are configured to: divide the weighted sum within each group by the distinct distance associated with each group to obtain a distance-weighted exposure measure for each group; and obtain a sum of a plurality of distance-weighted exposure measures for the plurality of groups.
Clause 40: The device of any of clauses 24 to 39, wherein the one or more processors, when determining the AEM, are configured to: subtract a customer-related measure from the sum of the plurality of distance-weighted exposure measures.
Clause 41: The device of any of clauses 24 to 40, wherein the customer-related measure is based at least in part on a customer-set variable or constant.
Clause 42: The device of any of clauses 24 to 41, wherein the customer-related measure is associated with local security control (LSC) and is based at least in part on: an endpoint detection and response (EDR) parameter; a Linux Foundation (LF) security parameter; local or built-in firewall parameter; system and kernel hardening level parameter; an antivirus (AV) parameter; and or any combination thereof.
Clause 43: The device of any of clauses 24 to 42, wherein the one or more processors, either alone or in combination, are further configured to: determine whether each asset of the plurality of source assets and the target asset represents an account or identity that has LSC; and determine whether the LSC of each asset is related to a presence or absence of two-factor authentication (2FA) or multi-factor authentication (MFA).
Clause 44: The device of any of clauses 24 to 43, wherein the one or more processors, either alone or in combination, are further configured to: determine a security configuration of the device based on one or more security benchmarks; and determine hardening of the device, wherein the system and kernel hardening level parameter is based on the security configuration and hardening of the device.
Clause 45: The device of any of clauses 24 to 44, wherein the groupings of the plurality of attack paths are based on: network and security posture of a plurality of source nodes associated with the plurality of source assets, respectively; a determination of one or more weaknesses, misconfigurations or vulnerabilities associated with one or more attack paths known to be exploited by an adversary; and or any combination thereof.
Clause 46: The device of any of clauses 24 to 45, wherein the network and security posture is based on: a determination of whether each source asset of the plurality of source assets is a digital asset or a cloud asset; a determination of whether each source asset of the plurality of source assets is Internet-facing; a determination of whether each source node of the plurality of source nodes has local security control (LSC); and or any combination thereof.
Clause 47: A non-transitory computer-readable medium storing computer-executable instructions that, when executed by a device, cause the device to: determine a plurality of distances of a plurality of attack paths, wherein each attack path of the plurality of attack paths is an attack path from a respective source target of a plurality of source assets to a target asset; determine an asset exposure measure (AEM) of the target asset based at least in part on groupings of the plurality of attack paths from the source assets to the target asset; and perform one or more actions based on the AEM.
Clause 48: The non-transitory computer-readable medium of clause 47, wherein the computer-executable instructions that, when executed by the device, cause the device to perform the one or more actions comprise computer-executable instructions that, when executed by the device, cause the device to: rank the target asset among a group of assets to facilitate a remediation of vulnerabilities or weaknesses; perform the remediation; output a vulnerability report; and or any combination thereof.
Clause 49: The non-transitory computer-readable medium of any of clauses 47 to 48, wherein the computer-executable instructions that, when executed by the device, cause the device to determine the plurality of distances comprise computer-executable instructions that, when executed by the device, cause the device to: determine each distance of the plurality of distances based at least in part on one or more vulnerability or misconfiguration parameters associated with each attack path of the plurality of attack paths.
Clause 50: The non-transitory computer-readable medium of any of clauses 47 to 49, wherein the computer-executable instructions that, when executed by the device, cause the device to determine the AEM comprise computer-executable instructions that, when executed by the device, cause the device to: determine a category of each attack path of the plurality of attack paths among a plurality of categories of attack paths based on each distance of the plurality of distances; and determine the AEM based at least in part on the categories of attack paths from the source assets to the target asset.
Clause 51: The non-transitory computer-readable medium of any of clauses 47 to 50, wherein the computer-executable instructions that, when executed by the device, cause the device to determine the AEM further comprise computer-executable instructions that, when executed by the device, cause the device to: determine the AEM based on a weighted sum of a normalized number of attack paths within each category of the plurality of categories.
Clause 52: The non-transitory computer-readable medium of any of clauses 47 to 51, wherein the computer-executable instructions that, when executed by the device, cause the device to determine the AEM further comprise computer-executable instructions that, when executed by the device, cause the device to: determine the normalized number of attack paths within each category based on dividing a minimum of a constant and a number of attack paths within each category by the constant.
Clause 53: The non-transitory computer-readable medium of any of clauses 47 to 52, wherein the plurality of categories comprises: a critical exposure category; a high exposure category; a medium exposure category; and a low exposure category.
Clause 54: The non-transitory computer-readable medium of any of clauses 47 to 53, wherein the computer-executable instructions that, when executed by the device, cause the device to determine the AEM based on the weighted sum comprise computer-executable instructions that, when executed by the device, cause the device to: multiply a first normalized number of attack paths within the critical exposure category by a first weight to obtain a first exposure measure; multiply a second normalized number of attack paths within the high exposure category by a second weight to obtain a second exposure measure; multiply a third normalized number of attack paths within the medium exposure category by a third weight to obtain a third exposure measure; multiply a fourth normalized number of attack paths within the low exposure category by a fourth weight to obtain a fourth exposure measure; and add the first exposure measure, the second exposure measure, the third exposure measure and the fourth exposure measure to obtain the weighted sum.
Clause 55: The non-transitory computer-readable medium of any of clauses 47 to 54, wherein a sum of the first weight, the second weight, the third weight and the fourth weight is one.
Clause 56: The non-transitory computer-readable medium of any of clauses 47 to 55, wherein the computer-executable instructions that, when executed by the device, cause the device to determine the AEM further comprise computer-executable instructions that, when executed by the device, cause the device to: determine a weighted local security control (LSC) factor; and subtract the weighted LSC factor from the weighted sum to obtain a difference between the weighted sum and the weighted LSC factor.
Clause 57: The non-transitory computer-readable medium of any of clauses 47 to 56, wherein the computer-executable instructions that, when executed by the device, cause the device to determine the AEM further comprise computer-executable instructions that, when executed by the device, cause the device to: determine a weighted source node component associated with the source assets; and add the weighted source node component to the difference between the weighted sum and the weighted LSC factor.
Clause 58: The non-transitory computer-readable medium of any of clauses 47 to 57, wherein the computer-executable instructions that, when executed by the device, cause the device to determine the AEM further comprise computer-executable instructions that, when executed by the device, cause the device to: obtain a normalized number of source assets associated with each category; and add the normalized number of source assets associated with each category to the normalized number of attack paths within each category to obtain a sum for each category.
Clause 59: The non-transitory computer-readable medium of any of clauses 47 to 58, wherein the weighted sum is obtained by applying a distinct weight to the sum for each category.
Clause 60: The non-transitory computer-readable medium of any of clauses 47 to 59, further comprising computer-executable instructions that, when executed by the device, cause the device to: group the attack paths into a plurality of groups, wherein each group of the plurality of groups is associated with a distinct distance among the plurality of distances.
Clause 61: The non-transitory computer-readable medium of any of clauses 47 to 60, wherein the computer-executable instructions that, when executed by the device, cause the device to determine the AEM comprise computer-executable instructions that, when executed by the device, cause the device to: obtain a normalized number of attack paths that reach the target asset within each group; obtain a normalized number of distinct source assets that are origins of the attack paths within each group; and obtain a weighted sum of the normalized number of attack paths and the normalized number of distinct source assets within each group.
Clause 62: The non-transitory computer-readable medium of any of clauses 47 to 61, wherein the computer-executable instructions that, when executed by the device, cause the device to determine the AEM further comprise computer-executable instructions that, when executed by the device, cause the device to: divide the weighted sum within each group by the distinct distance associated with each group to obtain a distance-weighted exposure measure for each group; and obtain a sum of a plurality of distance-weighted exposure measures for the plurality of groups.
Clause 63: The non-transitory computer-readable medium of any of clauses 47 to 62, wherein the computer-executable instructions that, when executed by the device, cause the device to determine the AEM further comprise computer-executable instructions that, when executed by the device, cause the device to: subtract a customer-related measure from the sum of the plurality of distance-weighted exposure measures.
Clause 64: The non-transitory computer-readable medium of any of clauses 47 to 63, wherein the customer-related measure is based at least in part on a customer-set variable or constant.
Clause 65: The non-transitory computer-readable medium of any of clauses 47 to 64, wherein the customer-related measure is associated with local security control (LSC) and is based at least in part on: an endpoint detection and response (EDR) parameter; a Linux Foundation (LF) security parameter; local or built-in firewall parameter; system and kernel hardening level parameter; an antivirus (AV) parameter; and or any combination thereof.
Clause 66: The non-transitory computer-readable medium of any of clauses 47 to 65, further comprising computer-executable instructions that, when executed by the device, cause the device to: determine whether each asset of the plurality of source assets and the target asset represents an account or identity that has LSC; and determine whether the LSC of each asset is related to a presence or absence of two-factor authentication (2FA) or multi-factor authentication (MFA).
Clause 67: The non-transitory computer-readable medium of any of clauses 47 to 66, further comprising computer-executable instructions that, when executed by the device, cause the device to: determine a security configuration of the device based on one or more security benchmarks; and determine hardening of the device, wherein the system and kernel hardening level parameter is based on the security configuration and hardening of the device.
Clause 68: The non-transitory computer-readable medium of any of clauses 47 to 67, wherein the groupings of the plurality of attack paths are based on: network and security posture of a plurality of source nodes associated with the plurality of source assets, respectively; a determination of one or more weaknesses, misconfigurations or vulnerabilities associated with one or more attack paths known to be exploited by an adversary; and or any combination thereof.
Clause 69: The non-transitory computer-readable medium of any of clauses 47 to 68, wherein the network and security posture is based on: a determination of whether each source asset of the plurality of source assets is a digital asset or a cloud asset; a determination of whether each source asset of the plurality of source assets is Internet-facing; a determination of whether each source node of the plurality of source nodes has local security control (LSC); and or any combination thereof.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line, or wireless technologies such as infrared, radio, and microwave, then the coaxial cable, fiber optic cable, twisted pair, digital subscriber line, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method performed by a device, comprising:
determining a plurality of distances of a plurality of attack paths, wherein each attack path of the plurality of attack paths is an attack path from a respective source target of a plurality of source assets to a target asset;
determining an asset exposure measure (AEM) of the target asset based at least in part on groupings of the plurality of attack paths from the source assets to the target asset; and
performing one or more actions based on the AEM.

2. The method of claim 1, wherein performing the one or more actions comprises:
ranking the target asset among a group of assets to facilitate a remediation of vulnerabilities or weaknesses;
performing the remediation;
outputting a vulnerability report;
or any combination thereof.

3. The method of claim 1, wherein determining the plurality of distances comprises:
determining each distance of the plurality of distances based at least in part on one or more vulnerability or misconfiguration parameters associated with each attack path of the plurality of attack paths.

4. The method of claim 1, wherein determining the AEM comprises:
determining a category of each attack path of the plurality of attack paths among a plurality of categories of attack paths based on each distance of the plurality of distances; and
determining the AEM based at least in part on the categories of attack paths from the source assets to the target asset.

5. The method of claim 4, wherein determining the AEM further comprises:
determining the AEM based on a weighted sum of a normalized number of attack paths within each category of the plurality of categories.

6. The method of claim 5, wherein determining the AEM further comprises:
determining the normalized number of attack paths within each category based on dividing a minimum of a constant and a number of attack paths within each category by the constant.

7. The method of claim 5, wherein the plurality of categories comprises:
a critical exposure category;
a high exposure category;
a medium exposure category; and
a low exposure category.

8. The method of claim 7, wherein determining the AEM based on the weighted sum comprises:
multiplying a first normalized number of attack paths within the critical exposure category by a first weight to obtain a first exposure measure;
multiplying a second normalized number of attack paths within the high exposure category by a second weight to obtain a second exposure measure;
multiplying a third normalized number of attack paths within the medium exposure category by a third weight to obtain a third exposure measure;
multiplying a fourth normalized number of attack paths within the low exposure category by a fourth weight to obtain a fourth exposure measure; and
adding the first exposure measure, the second exposure measure, the third exposure measure and the fourth exposure measure to obtain the weighted sum.

9. The method of claim 8, wherein a sum of the first weight, the second weight, the third weight and the fourth weight is one.

10. The method of claim 5, wherein determining the AEM further comprises:
determining a weighted local security control (LSC) factor; and
subtracting the weighted LSC factor from the weighted sum to obtain a difference between the weighted sum and the weighted LSC factor.

11. The method of claim 10, wherein determining the AEM further comprises:
determining a weighted source node component associated with the source assets; and
adding the weighted source node component to the difference between the weighted sum and the weighted LSC factor.

12. The method of claim 5, wherein determining the AEM further comprises:
obtaining a normalized number of source assets associated with each category; and
adding the normalized number of source assets associated with each category to the normalized number of attack paths within each category to obtain a sum for each category.

13. The method of claim 12, wherein the weighted sum is obtained by applying a distinct weight to the sum for each category.

14. The method of claim 1, further comprising:
grouping the attack paths into a plurality of groups, wherein each group of the plurality of groups is associated with a distinct distance among the plurality of distances.

15. The method of claim 14, wherein determining the AEM comprises:
obtaining a normalized number of attack paths that reach the target asset within each group;
obtaining a normalized number of distinct source assets that are origins of the attack paths within each group; and
obtaining a weighted sum of the normalized number of attack paths and the normalized number of distinct source assets within each group.

16. The method of claim 15, wherein determining the AEM further comprises:
dividing the weighted sum within each group by the distinct distance associated with each group to obtain a distance-weighted exposure measure for each group; and
obtaining a sum of a plurality of distance-weighted exposure measures for the plurality of groups.

17. The method of claim 16, wherein determining the AEM further comprises:
subtracting a customer-related measure from the sum of the plurality of distance-weighted exposure measures.

18. The method of claim 17, wherein the customer-related measure is based at least in part on a customer-set variable or constant.

19. The method of claim 17, wherein the customer-related measure is associated with local security control (LSC) and is based at least in part on:
an endpoint detection and response (EDR) parameter;
a Linux Foundation (LF) security parameter;
local or built-in firewall parameter;
system and kernel hardening level parameter;
an antivirus (AV) parameter;
or any combination thereof.

20. The method of claim 19, further comprising:
determining whether each asset of the plurality of source assets and the target asset represents an account or identity that has LSC; and
determining whether the LSC of each asset is related to a presence or absence of two-factor authentication (2FA) or multi-factor authentication (MFA).

21. The method of claim 19, further comprising:
determining a security configuration of the device based on one or more security benchmarks; and
determining hardening of the device, wherein the system and kernel hardening level parameter is based on the security configuration and hardening of the device.

22. The method of claim 1, wherein the groupings of the plurality of attack paths are based on:
network and security posture of a plurality of source nodes associated with the plurality of source assets, respectively;
a determination of one or more weaknesses, misconfigurations or vulnerabilities associated with one or more attack paths known to be exploited by an adversary;
or any combination thereof.

23. The method of claim 22, wherein the network and security posture is based on:
a determination of whether each source asset of the plurality of source assets is a digital asset or a cloud asset;
a determination of whether each source asset of the plurality of source assets is Internet-facing;
a determination of whether each source node of the plurality of source nodes has local security control (LSC);
or any combination thereof.

24. A device, comprising:
one or more memories; and
one or more processors communicatively coupled to the one or more memories, the one or more processors, either alone or in combination, configured to:
determine a plurality of distances of a plurality of attack paths, wherein each attack path of the plurality of attack paths is an attack path from a respective source target of a plurality of source assets to a target asset;
determine an asset exposure measure (AEM) of the target asset based at least in part on groupings of the plurality of attack paths from the source assets to the target asset; and
perform one or more actions based on the AEM.

25. The device of claim 24, wherein the one or more processors, when performing the one or more actions, are configured to:
rank the target asset among a group of assets to facilitate a remediation of vulnerabilities or weaknesses;
perform the remediation;
output a vulnerability report; and
or any combination thereof.

26. The device of claim 24, wherein the one or more processors, when determining the plurality of distances, are configured to:
determine each distance of the plurality of distances based at least in part on one or more vulnerability or misconfiguration parameters associated with each attack path of the plurality of attack paths.

27. The device of claim 24, wherein the one or more processors, when determining the AEM, are configured to:
determine a category of each attack path of the plurality of attack paths among a plurality of categories of attack paths based on each distance of the plurality of distances; and
determine the AEM based at least in part on the categories of attack paths from the source assets to the target asset.

28. The device of claim 27, wherein the one or more processors, when determining the AEM, are configured to:
determine the AEM based on a weighted sum of a normalized number of attack paths within each category of the plurality of categories.

29. The device of claim 28, wherein the one or more processors, when determining the AEM, are configured to:
determine the normalized number of attack paths within each category based on dividing a minimum of a constant and a number of attack paths within each category by the constant.

30. The device of claim 28, wherein the plurality of categories comprises:
a critical exposure category;
a high exposure category;
a medium exposure category; and
a low exposure category.

31. The device of claim 30, wherein the one or more processors, when determining the AEM based on the weighted sum, are configured to:
multiply a first normalized number of attack paths within the critical exposure category by a first weight to obtain a first exposure measure;
multiply a second normalized number of attack paths within the high exposure category by a second weight to obtain a second exposure measure;
multiply a third normalized number of attack paths within the medium exposure category by a third weight to obtain a third exposure measure;
multiply a fourth normalized number of attack paths within the low exposure category by a fourth weight to obtain a fourth exposure measure; and
add the first exposure measure, the second exposure measure, the third exposure measure and the fourth exposure measure to obtain the weighted sum.

32. The device of claim 31, wherein a sum of the first weight, the second weight, the third weight and the fourth weight is one.

33. The device of claim 28, wherein the one or more processors, when determining the AEM, are configured to:
determine a weighted local security control (LSC) factor; and
subtract the weighted LSC factor from the weighted sum to obtain a difference between the weighted sum and the weighted LSC factor.

34. The device of claim 33, wherein the one or more processors, when determining the AEM, are configured to:
determine a weighted source node component associated with the source assets; and
add the weighted source node component to the difference between the weighted sum and the weighted LSC factor.

35. The device of claim 28, wherein the one or more processors, when determining the AEM, are configured to:
obtain a normalized number of source assets associated with each category; and
add the normalized number of source assets associated with each category to the normalized number of attack paths within each category to obtain a sum for each category.

36. The device of claim 35, wherein the weighted sum is obtained by applying a distinct weight to the sum for each category.

37. The device of claim 24, wherein the one or more processors, either alone or in combination, are further configured to:
group the attack paths into a plurality of groups, wherein each group of the plurality of groups is associated with a distinct distance among the plurality of distances.

38. The device of claim 37, wherein the one or more processors, when determining the AEM, are configured to:
obtain a normalized number of attack paths that reach the target asset within each group;
obtain a normalized number of distinct source assets that are origins of the attack paths within each group; and
obtain a weighted sum of the normalized number of attack paths and the normalized number of distinct source assets within each group.

39. The device of claim 38, wherein the one or more processors, when determining the AEM, are configured to:
divide the weighted sum within each group by the distinct distance associated with each group to obtain a distance-weighted exposure measure for each group; and
obtain a sum of a plurality of distance-weighted exposure measures for the plurality of groups.

40. The device of claim 39, wherein the one or more processors, when determining the AEM, are configured to:
subtract a customer-related measure from the sum of the plurality of distance-weighted exposure measures.

41. The device of claim 40, wherein the customer-related measure is based at least in part on a customer-set variable or constant.

42. The device of claim 40, wherein the customer-related measure is associated with local security control (LSC) and is based at least in part on:
an endpoint detection and response (EDR) parameter;
a Linux Foundation (LF) security parameter;
local or built-in firewall parameter;
system and kernel hardening level parameter;
an antivirus (AV) parameter; and
or any combination thereof.

43. The device of claim 42, wherein the one or more processors, either alone or in combination, are further configured to:
determine whether each asset of the plurality of source assets and the target asset represents an account or identity that has LSC; and
determine whether the LSC of each asset is related to a presence or absence of two-factor authentication (2FA) or multi-factor authentication (MFA).

44. The device of claim 42, wherein the one or more processors, either alone or in combination, are further configured to:
determine a security configuration of the device based on one or more security benchmarks; and
determine hardening of the device, wherein the system and kernel hardening level parameter is based on the security configuration and hardening of the device.

45. The device of claim 24, wherein the groupings of the plurality of attack paths are based on:
network and security posture of a plurality of source nodes associated with the plurality of source assets, respectively;
a determination of one or more weaknesses, misconfigurations or vulnerabilities associated with one or more attack paths known to be exploited by an adversary; and
or any combination thereof.

46. The device of claim 45, wherein the network and security posture is based on:
a determination of whether each source asset of the plurality of source assets is a digital asset or a cloud asset;
a determination of whether each source asset of the plurality of source assets is Internet-facing;
a determination of whether each source node of the plurality of source nodes has local security control (LSC); and
or any combination thereof.

47. A non-transitory computer-readable medium storing computer-executable instructions that, when executed by a device, cause the device to:
determine a plurality of distances of a plurality of attack paths, wherein each attack path of the plurality of attack paths is an attack path from a respective source target of a plurality of source assets to a target asset;
determine an asset exposure measure (AEM) of the target asset based at least in part on groupings of the plurality of attack paths from the source assets to the target asset; and
perform one or more actions based on the AEM.
